(19) United States
(12) Patent Application Publication
(10) Pub. No.: US 2005/0231513 A1
(43) Pub. Date: Oct. 20, 2005

(54) Stop motion capture tool using image cutouts

(76) Inventors: Jeffrey LeBarton, Burbank, CA (US); Chava LeBarton, Burbank, CA (US); John Christopher Williams, Los Angeles, CA (US)

Correspondence Address: GREENBERG TRAURIG LLP, 2450 COLORADO AVENUE, SUITE 400E, SANTA MONICA, CA, 90404, US

(21) Appl. No.: 11/151,856

(22) Filed: Jun. 13, 2005

Related U.S. Application Data
(63) Continuation-in-part of application No. 10/897,512, filed on Jul. 23, 2004.
(60) Provisional application No. 60/481,128, filed on Jul. 23, 2003.

(51) Int. Cl. G06T 15/70; G06T 13/00

(52) U.S. Cl. 345/473

(57) ABSTRACT

A computer software method for creating a computer animation using static and animated images is disclosed. The computer software method provides a user interface that has a first window portion and a second window portion. In the first window portion, images can be manipulated to create a frame, the frame being one of a plurality of frames which make up a computer animation. The second window portion displays the plurality of frames thus allowing previewing the computer animation. The computer software method permits a user to load at least one image into the first window portion. The at least one image in the first window portion can be edited and manipulated so as to build a scene. The user can then create a frame by capturing the contents of the first window. The computer software adds the newly created frame to the plurality of frames displayed in the second window portion. The plurality of frames is then displayed in the second window portion as an animation.

### RELATED APPLICATIONS

This Application is a continuation-in-part of U.S. patent application Ser. No. 10/897,512, filed Jul. 23, 2004, which in turn claims the priority date of U.S. Provisional Application No. 60/481,128, filed on Jul. 23, 2003. The contents of those applications are incorporated by reference herein.

### BACKGROUND OF THE DISCLOSURE

1. Field of the Disclosure

The present disclosure relates to computer animations. In particular, it relates to methods and systems to create stop motion computer animations utilizing digital image cutouts, static images and animated images.

2. General Background

Stop motion capture is a technique used to create films or animations. Stop-motion animations are created by placing an object, taking a picture of it, moving the object, taking another picture, and then continuously repeating that. Stop motion capture is also used to create films or animations by placing one drawing of a sequence of drawings, taking a picture of it, placing the next drawing from the sequence, taking another picture, and then repeating that process over and over.

This is traditionally hard to do because one generally cannot see the result of the animation until the animation has been created in its totality, and there's no easy way to go back and edit just one piece of it.

Stop motion animation is a technique that can be used to make still objects come to life. For example, clay figures, puppets and cutouts may be used and moved slightly, taking images with every movement. When the images are put together, the figures appear to move.

Many older movie cameras include the ability to shoot one frame at a time, rather than at full running speed. Each time the camera trigger is clicked, you expose a single frame of film. When all captured frames are projected at running speed, they combine to create motion, just like any footage that had been shot ‘normally’ at running speed.

On current video cameras, this is not usually possible; however, the very same thing can be achieved with the appropriate video editing software and computer. Video editing software can select single frames from video captured with a video camera. When those frames are played back at full running speed, the result is motion, just like with the older movie camera. The technique is the same; each frame is recorded to the hard drive of your computer instead of to a frame of movie film.

Software created for “stop motion” animation literally, through a series of stopped motion, creates the illusion of movement. There are currently several software applications available that provide stop motion capture. Existing stop motion software products are either too complex or too simple to make them useful to the general, non-professional public.

For example, “pencil testing” applications are commonly used in the animation industry to test the quality of movements of a plurality of sketches or images. These pencil testing applications are quite simplistic. They only allow for assembly and playback of images and do not offer any other functions.

Existing stop motion software that is directed to the general consumer, or for teaching purposes, also requires the use of additional software to create original audio. Completing an animation short including: title, animation, sound effects, and depending on the story, voiceovers and background music, within one stop motion animation software application is not possible with any existing products on the market.

Therefore, it is desired to have a single software application that provides all the functions for creating a stop motion animation in an easy to use environment suitable for use by non-professional users across a wide age range.

### SUMMARY

A computer software method for creating a computer animation using digital static and animated images is disclosed. The computer software method provides a user interface that has a first window portion and a second window portion. In the first window portion, images can be manipulated to create a frame, the frame being one of a plurality of frames which make up a computer animation. The second window portion displays the plurality of frames thus allowing previewing the computer animation.

Individual frames are created by selecting one or more images, manipulating the images, and capturing the images together as a single image. In order to create a frame, the images first have to be placed in the first window portion. The program may provide pre-programmed background images, characters, and props for creating frames.

Alternatively, the user may load additional static images, animated images, or digital cutout characters. The computer software method permits a user to load at least one image into the first window portion. Images can be obtained, for example, from a non-volatile storage medium, a digital camera, a web camera attached to the computer, or the Internet. A computer is considered any device comprising a processor, memory, display, and appropriate user input device (such as mouse, keyboard, etc). The user can record audio (via Mic/Line-in) and/or insert sound effects and music accompaniment to play along with the animation.

The image loaded on the first window portion can be a character image having multiple body parts, each body part being represented by an image cutout. The image can also be a two-dimensional image or a three-dimensional image. In another aspect, the image can be a video image.

The image in the first window portion can be edited and manipulated to build a scene. The cutout image may be manipulated by moving it from a first position to a second position. Furthermore, the cutout image can be edited by being resized, rotated, or cropped.

If the image is a character image having multiple body parts, the character image can be edited so that the head edited so that the head can be replaced with a second image. Likewise, an image portion of the character image corresponding to the mouth of the character can be cropped and moved back and forth to simulate movement of the character's mouth. When a character is moved and manipulated, the character is treated as a single unit and moving the character moves all the parts of the character together. Each body of the character, however, can also be moved independently such as moving a limb or the head. Character resizing can also be done as a whole unit, where all the body parts resize in proportion to each other. Furthermore, each body part can be resized independently if the user so desires.

Because the first window contains a background an image cutouts, the captured frame will contain exactly the same background and image cutout, except the capture frame is a single image. For example, a frame may comprise a background, character, and a prop. Such a frame might be created by choosing a background image, a character image, and a prop image.

The second application window can display the contents of the first application window including any editing or manipulation done in the first window. For example, when an image is manipulated on the first application window, the manipulation is also displayed in the second application window.

In another aspect, the user is provided with the ability to save a sequence of movements of an image such that the saved sequence of movements may be applied to a second image on the first application window. In one embodiment, the second image to which the sequence of movements is applied is a character. More generally, there is a method of saving a sequence of movement which comprises recording the scaling, rotation, body part selection, body part position relative to the torso, of an character or image, and applying the recorded sequence to another character or image.

Once the character and object images have been manipulated to the user's liking the frame is captured. The frame can be captured in various manners. In one aspect, the user is provided with a clickable “snapshot” button to capture the contents of the first application window as a single image.

The frame can be comprised of a background image and at least one character image, wherein the at least one character image is overlaid on the background image. In one aspect, the first application window can comprise a plurality of layers, each layer of the plurality of layers corresponding to each image loaded to the first application window, and wherein the frame is made by superposing each layer in the plurality of layers so as to create a single image. In yet another aspect, the user may also insert and synchronize audio to the sequence of frames by attaching an audio cue to the image where the audio is to begin.

After a frame is captured within the first portion of the user interface, the frame is added to the plurality of frames and displayed in the second portion of the user interface. The computer software adds the newly created frame to the plurality of frames displayed in the second window portion.

Any frame captured can later be deleted from the plurality of frames. Likewise, a frame can be inserted before or after another frame in the plurality of frames. The plurality of frames can be displayed in the second window portion as an animation. In another aspect, the plurality of frames can be viewed in the order in which the frames were added. The sequential display of the plurality of frames can be compiled in the form of a video or an animation.

### BRIEF DESCRIPTION OF THE DRAWINGS

FIG. 1 illustrates a flow diagram of the process to create a computer animation.

FIG. 2 illustrates a flow diagram of the process of arranging and setting a scene.

FIG. 3 illustrates a computer screen shot of the computer interface showing the common user interface elements of the application available in any mode.

FIG. 4A illustrates a computer screen shot of the application in set mode.

FIG. 4B illustrates a computer screen shot of the application in set mode when a character is being loaded.

FIG. 4C illustrates a computer screen shot of the application in set mode when a character is being edited with the facelift feature.

FIG. 4D illustrates a computer screen shot of the application in set mode when a character is being edited with the jaw-drop feature.

FIG. 5A illustrates a computer screen shot of the application in action mode.

FIG. 5B illustrates a computer screen shot of the application in action mode displaying a functionality to capture multiple frames.

FIG. 6A illustrates a computer screen shot of the application in sound mode.

FIG. 6B illustrates a computer screen shot of the application in sound mode displaying various audio options.

FIG. 7A illustrates a computer screen shot of the application in mods mode.

FIG. 7B illustrates a computer screen shot of the application in mods mode displaying the frame capture module.

FIG. 7C illustrates a computer screen shot of the application in mods mode displaying the titles module.

FIG. 7D illustrates a computer screen shot of the application in mods mode displaying the blue screen module using the LIVE functionality.

FIG. 7E illustrates a computer screen shot of the application in mods mode displaying the blue screen module using the POST functionality.

FIG. 7F illustrates a computer screen shot of the application in mods mode displaying the video import module.

FIG. 8 illustrates a computer screen shot of the application in exchange mode.

### DETAILED DESCRIPTION

In the following description of the present invention, reference is made to the accompanying drawings, which form a part thereof, and in which is shown by way of illustration, exemplary embodiments illustrating the principles of the present disclosure and how it may be practiced. It is to be understood that other embodiments may be utilized and structural and functional changes may be made thereto without departing from the scope of the present disclosure.

A method and system to create a computer animation is disclosed. The computer animation is created using a software based user interface, wherein a user can create and edit single frames of an animation and simultaneously view and sequence the plurality of frames that make up the animation.

In one embodiment, the creation and editing of individual frames is accomplished in a first portion of the user interface. A second portion of the user interface, which is displayed simultaneously with the first portion, is dedicated to displaying the plurality of frames that make up the animation, sequencing the frames, and previewing or playing the animation.

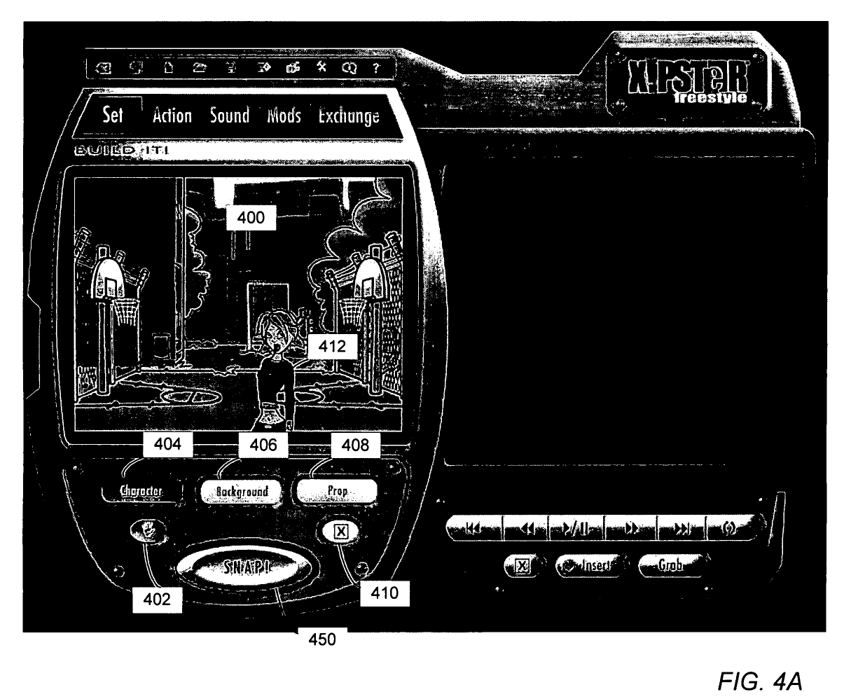

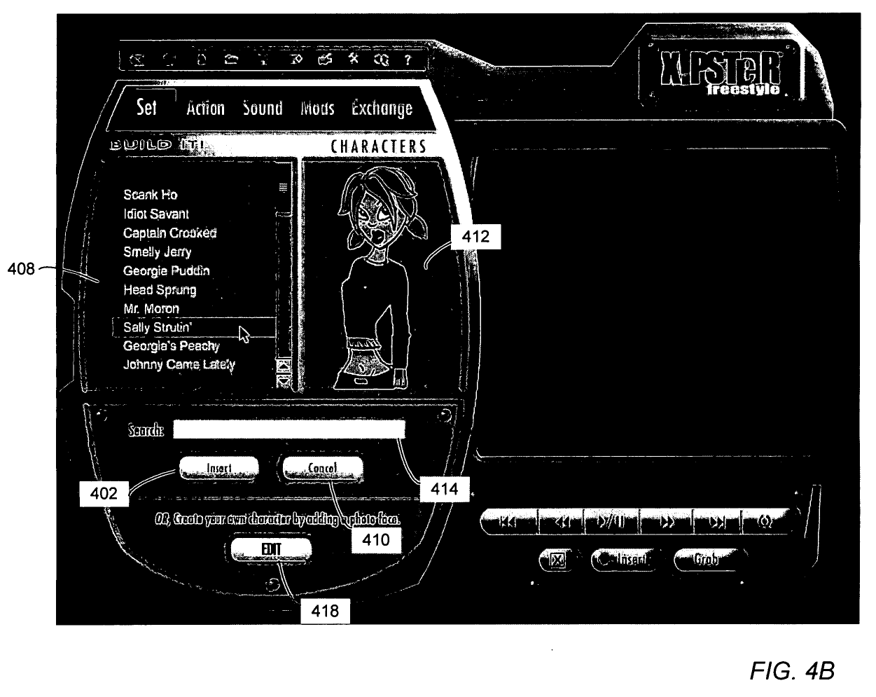

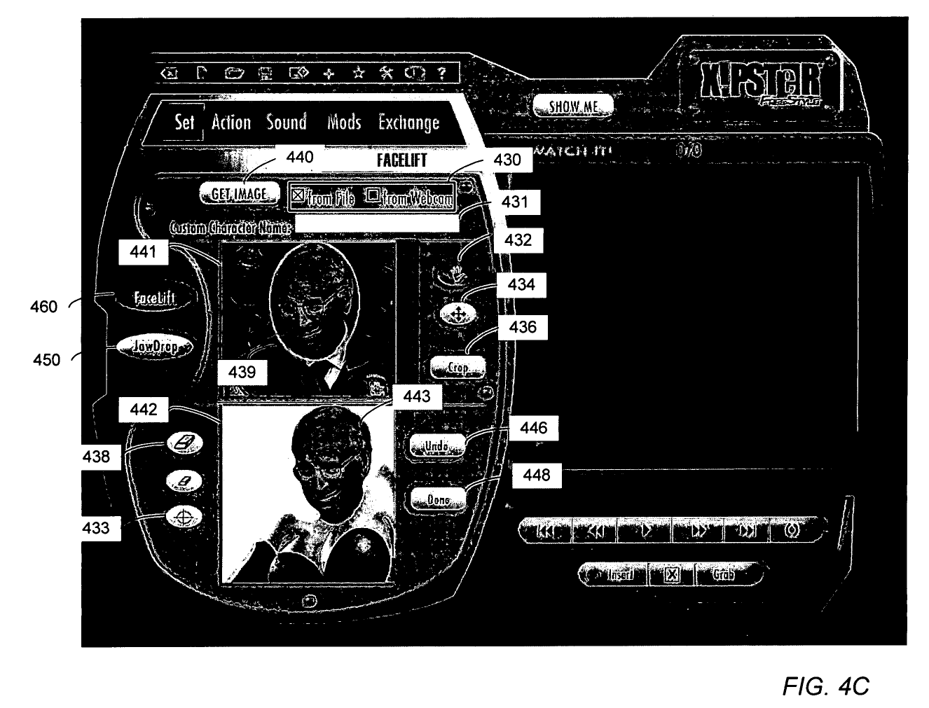

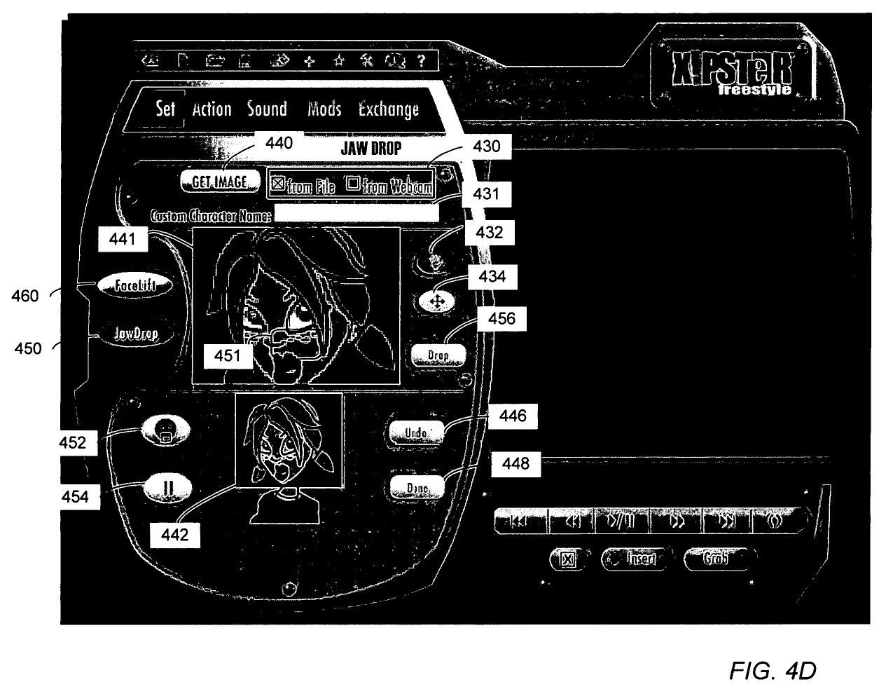

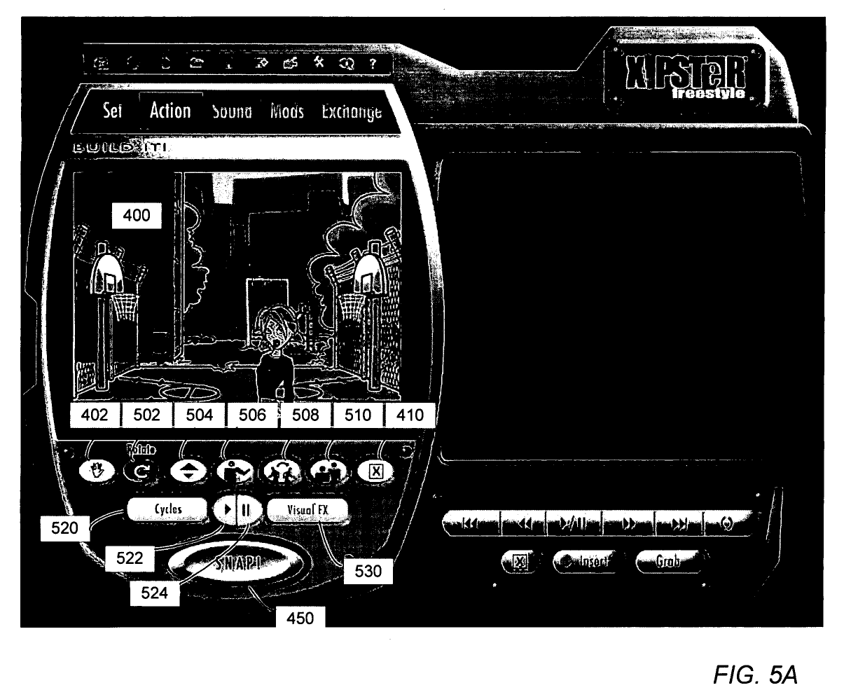

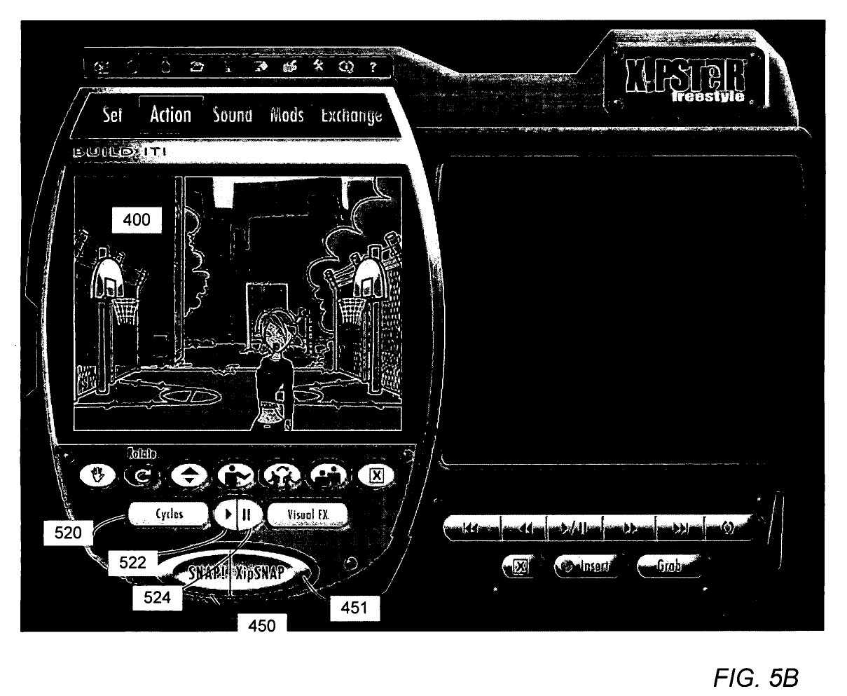

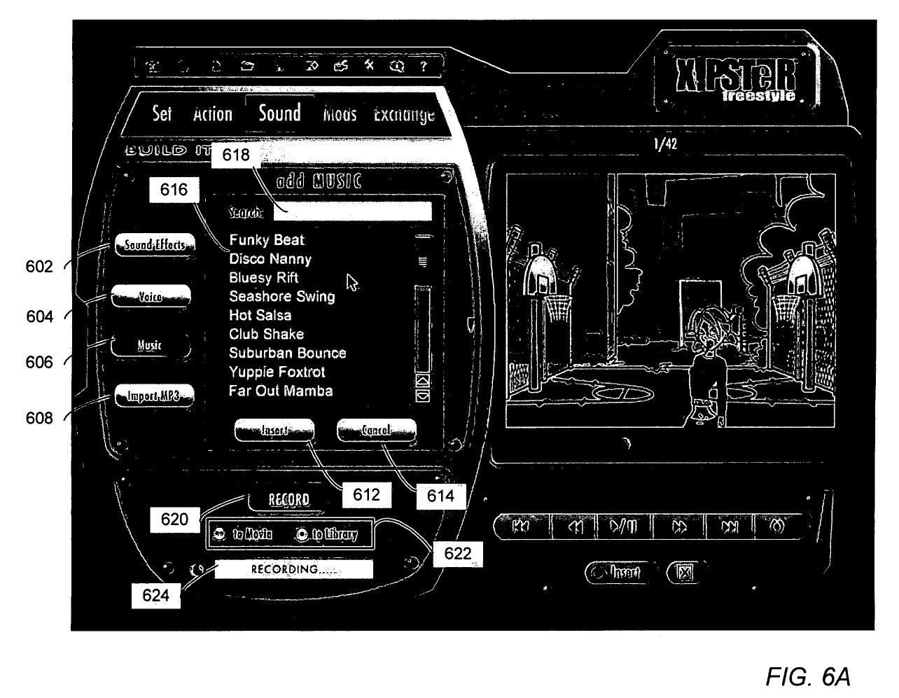

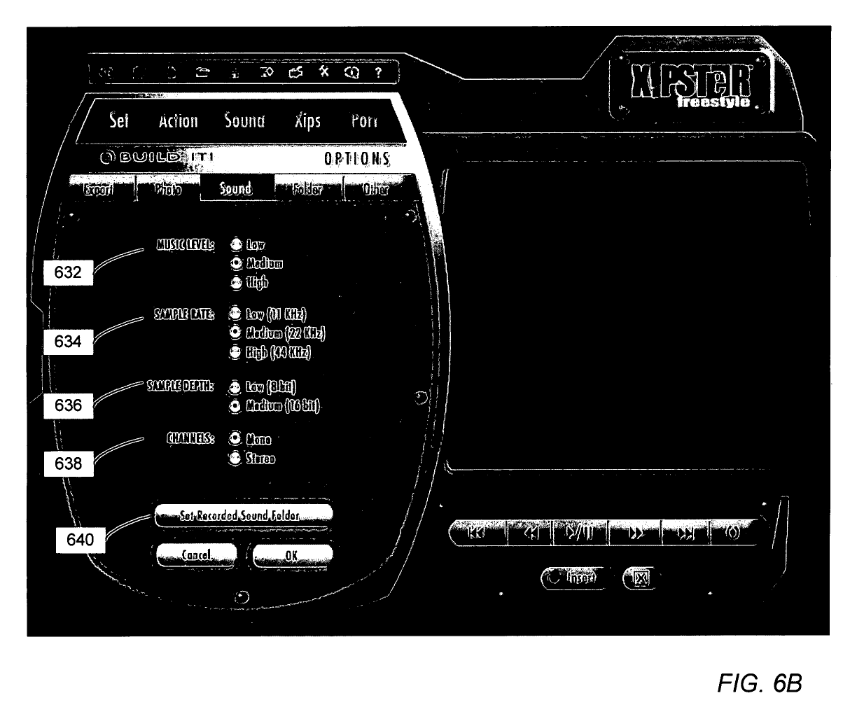

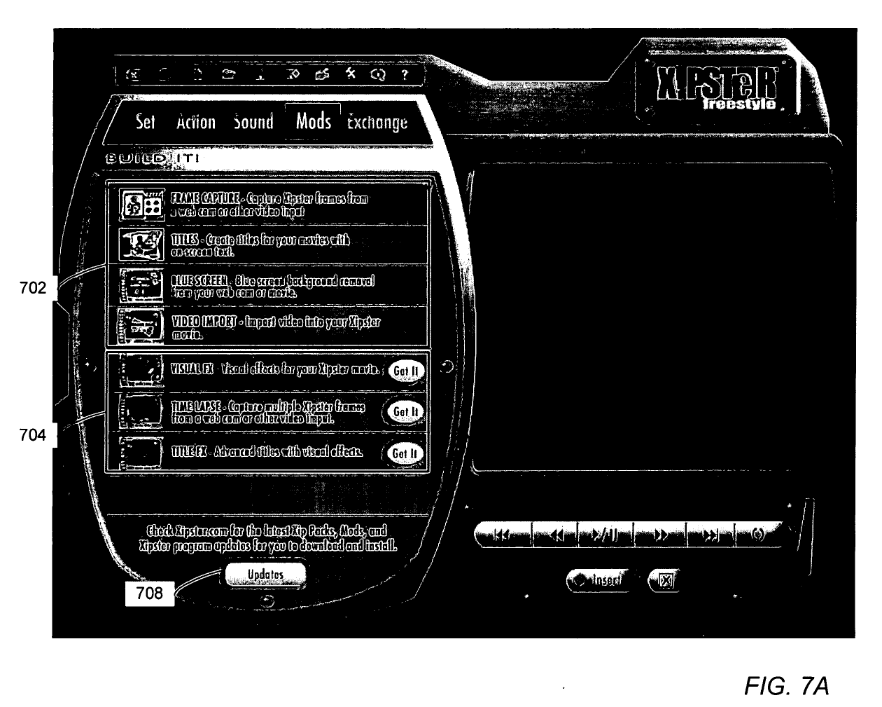

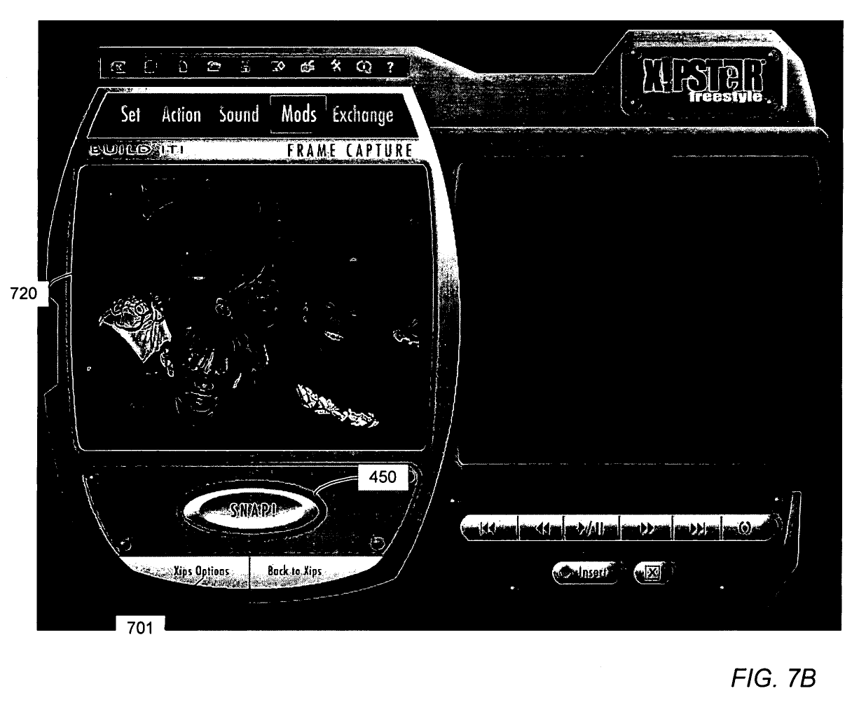

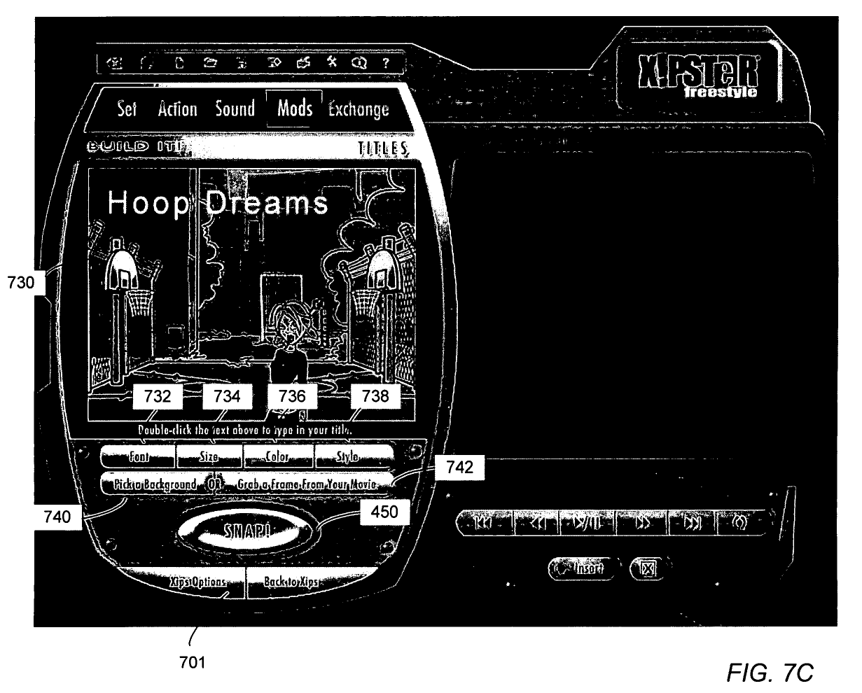

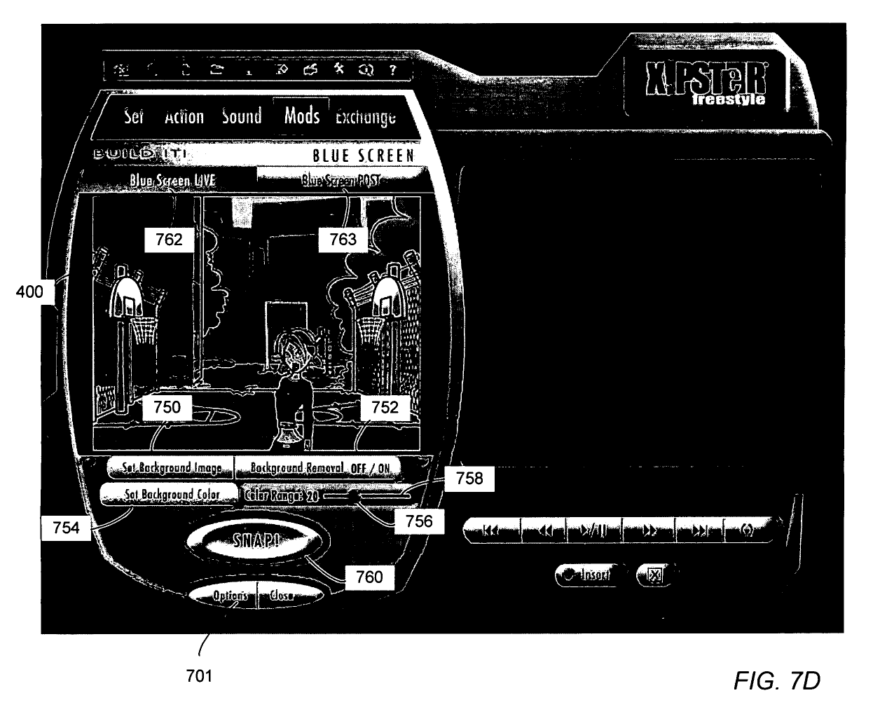

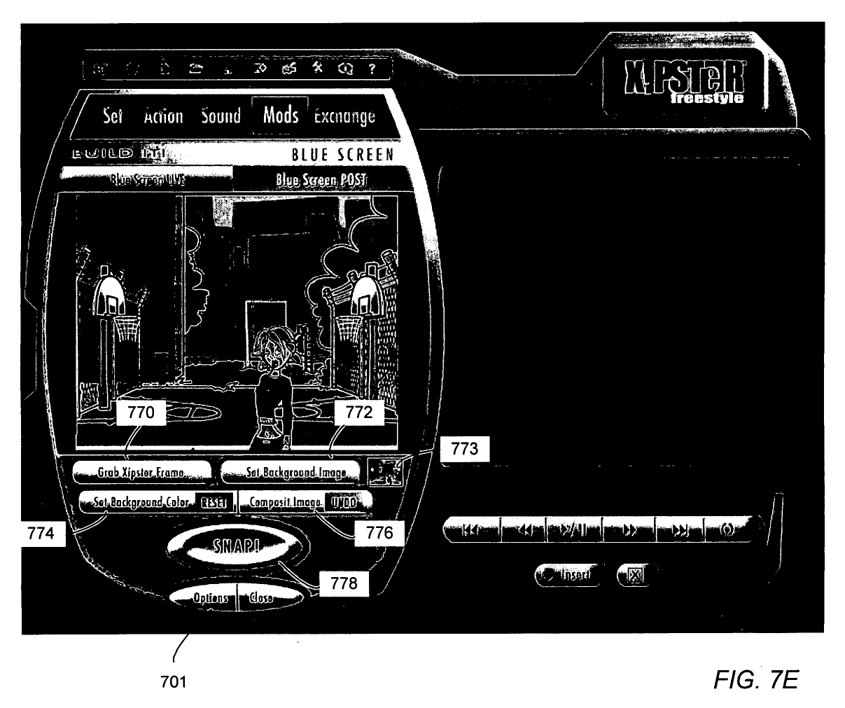

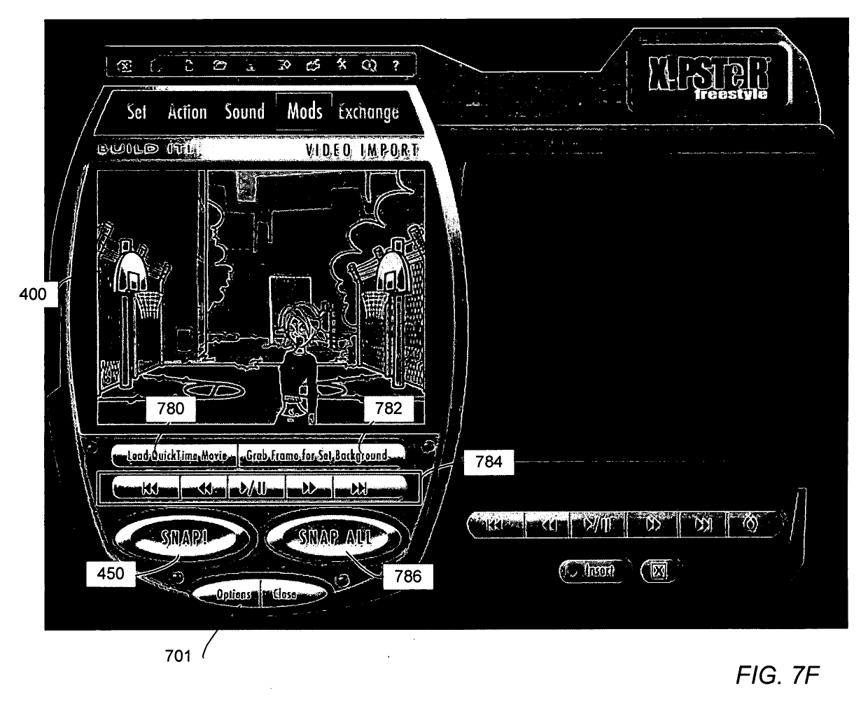

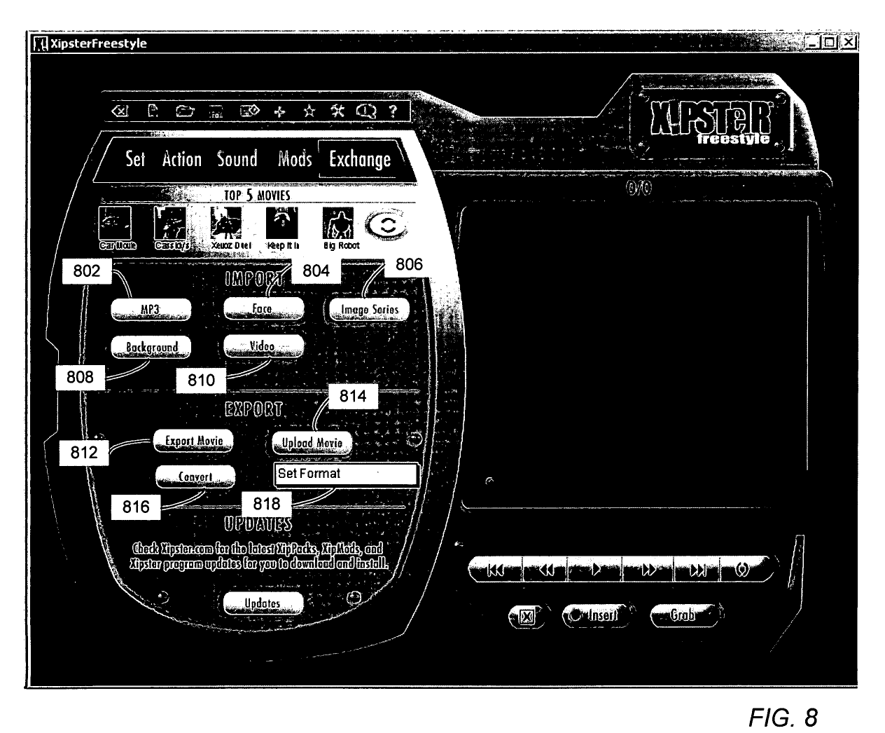

The first portion has different operation modes. In other words, the interactive elements of the first portion change depending on the mode. Example of operation modes are scene setting, action control, sound setting, adding extra features, and sharing with other users. The scene-setting mode is depicted in FIGS. 4A-4C. The action control mode is depicted in FIG. 5. The sound setting mode is depicted in FIGS. 6A-6B. The extra features mode is illustrated in FIGS. 7A-7F. The mode for sharing with other users is depicted in FIG. 8.

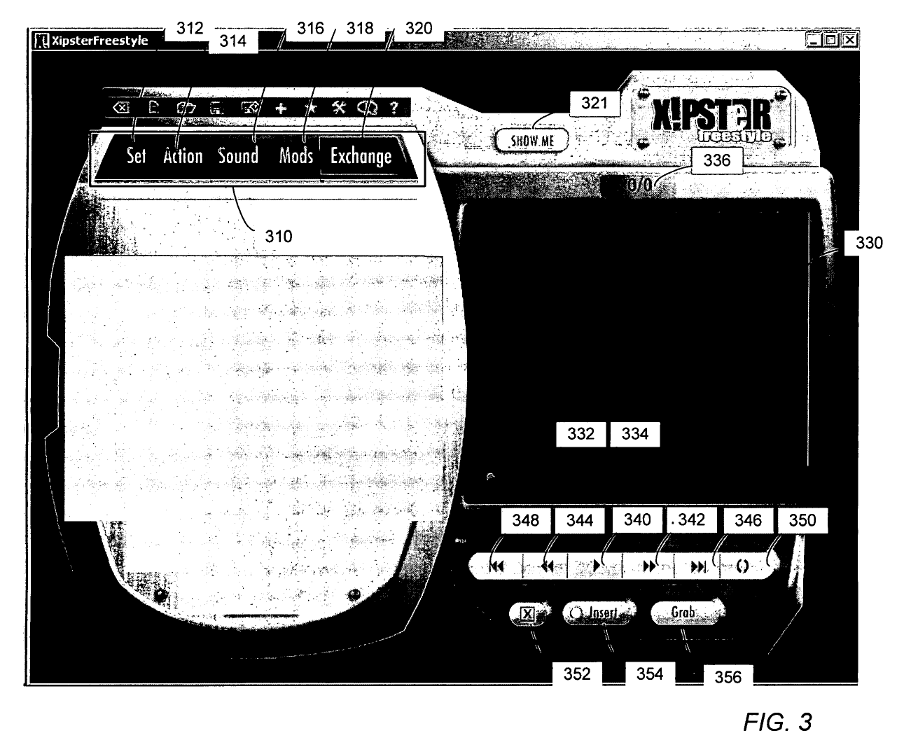

The second portion, depicted in FIG. 3, has common elements that are always available to the user regardless of the mode of operation. This portion contains common elements that provide the user with the ability to view the frames that have been shot.

These features are not exclusive to any one mode, but instead are shared by all modes within the stop motion capture application. These features, or common user interface elements, are accessible at all times from all modes. Furthermore, unlike other mode-specific features throughout the application, their functionality remains consistent throughout all modes.

Individual frames are created by selecting one or more images, manipulating the images, and capturing the images together as a single image. The program may provide pre-programmed background images, characters, and props for creating frames. For example, a frame may comprise a background, character, and other prop. Such a frame might be created by choosing a background image, a character image, and a prop image. Once the character and prop images have been manipulated to the user's liking (i.e. resizing, moving, etc.) the frame is captured.

After a frame is created and captured within the first portion of the user interface, the frame is added to the plurality of frames and displayed in the second portion of the user interface.

The user interface provides an easy to use and simple interface for choosing images to insert into the frame.

General Functionality

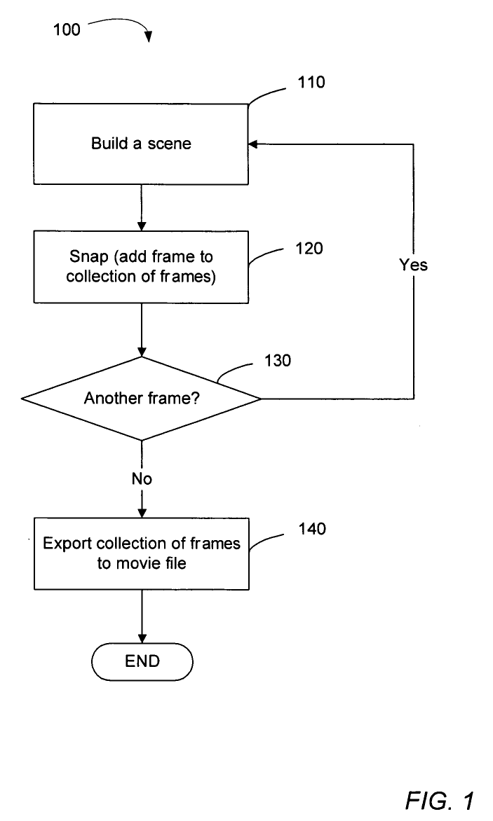

FIG. 1 illustrates a flow diagram of the process to create a computer animation. The application is designed to allow users to create digital stop motion animations by capturing a plurality of frames from a collection of images including backgrounds, image cutouts, and props to play back as an animation. In one embodiment, characters can be stored as digital cutout images. Backdrops and props can be stored as static images, and animated backgrounds, props, visual effects and Flash characters can be used as animated images.

Therefore, in process block 110, a user can build a scene by setting a specific background and manipulating images and sound. After the user is satisfied with how the scene has been set up the user takes a snapshot of the scene in process block 120. The snapshot of the scene captures a single image of the contents of the scene. This single image becomes a frame to be added to the plurality of frames.

In decision block 130, a user may desire to either add another frame or end the process of creating the animation. If the user selects to add another frame, the user will then build another scene for the next frame. In one embodiment, the previous scene will remain available to the user so that the user only has to make minor changes to the scene and then take another snapshot. In other words, subsequently created frames are created in the same manner as the previous frame, except the user does not need to start from “scratch.” Subsequent frames are created based on the last created frame. Therefore, minor adjustments may be made to each subsequent frame to show movement or other action easily. The user may nevertheless select a new background and change the arrangement of characters by adding or removing images. The user then takes a second snapshot to capture the contents of the scene after the changes have been made.

For the next frame, the user may once again modify the scene and take a snapshot as a single image. This process continues recursively until the user has shot a sufficient number of frames to achieve the computer animation and chooses not to add any more frames.

If the user chooses to not create another frame, in process block 140 the user may then export the collection of frames to a video file. The final output plays back the user's custom movie with custom audio synched to the playback.

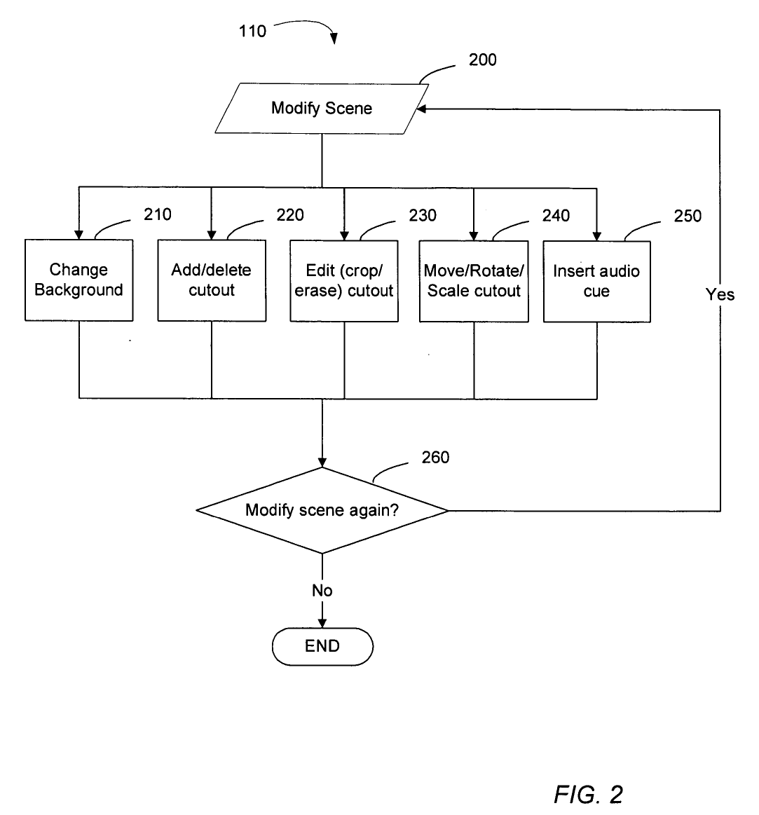

FIG. 2 illustrates a flow diagram of the process of arranging and setting a scene. In the input block 200, the user selects to modify a scene by various operations such as set or change the background, adding or deleting an image, editing a image, moving or scaling a image, inserting audio, etc. The user may select to do any of these actions and continue to making modifications to the scene until the user is satisfied with the result of the scene. For example, the user may select to change the background of the scene in process block 210. The background may be changed at any time the user decides to modify the scene. Thereafter, in decision block 260 the user may choose to continue making changes to the scene. The user would then select another modification in input block 200.

In process block 220, the user may add or delete an image. In one embodiment, the image can be a character or a prop. Thus, a user may add more characters, objects or any other images to the scene. The user may add character by importing the character from a pre-stored source or by adding a new image. In process block 230, images can be edited by cropping, erasing, etc. In one embodiment, an image is added to be part of a character by importing the photograph of a person, cropping the face or the head of the person, erasing the edges, and adding the face to the character. In another embodiment, any image, character, prop, background, etc may be edited in process block 230.

In process block 240, a cutout may be moved from one position to another, scaled in or out, and rotated. Other forms of altering the cutout may be stretching, adding sequence of movements, mirroring, flipping, bringing to front, bringing to back, etc. If the cutout is a character, the character can be shrunk or enlarged as a one character even when the character is comprised by a plurality of cutouts. The character may also be placed in different positions such as preconfigured poses.

In process block 250, the scene may be flagged as to the scene where an audio cue may start playing. Audio cues include songs, pre-recorded voice, sound effects, etc.

Common User Interface Elements

FIG. 3 illustrates a computer screen shot of the computer interface showing the common user interface elements of the application available in any mode. As discussed above, in an exemplary embodiment, the stop motion capture application can include five modes: set, action, sound, mods and exchange. Each of these modes has common user interface elements that are represented in FIG. 3.

As is shown in FIGS. 4A to 8, these elements are present in each mode of the application. In one embodiment, a common user interface element is a mode selection bar 310. The mode selection bar 310 provides the ability for the user to easily switch from one mode to another, and thus includes multiple buttons to select a preferred mode of operation. For example, five mode switch buttons 312, 314, 316, 318, and 320 (Set, Action, Sound, Mods, and Exchange) are provided to easily switch from mode to another while also provide a visual indicator of the current mode by showing which mode switch button is pressed.

In another embodiment, the display window 330 is present in each mode of the application. The display window 330 displays the frames that have been captured by the user. Moreover, the content within display window 330 does not need to change depending on the mode that is selected. Rather, the current viewing frame can always be what is displayed in the display window 330.

Frames are displayed sequentially as a movie (when play is accessed) or individually on a frame-by-frame basis (using the back frame, forward frame, fast back, or fast forward buttons).

In yet another embodiment, the user interface of the stop motion animation software can further include a frame slider bar 332 which allows the user to quickly navigate through captured frames. The frame slider bar comprises a slider 334 that is used to scroll through the frames. The user can clicks and drag the slider (while still holding down the mouse button) to the desired location on the timeline, and then releases the mouse button. Once released, the display window updates to reveal the frame that is currently selected.

In one embodiment, the frame slider bar 332 is located within the display window 330, however the frame slider bar. 332 may be located wherever is most convenient in the user interface. Generally, in order to use the frame slider bar 332, the user must have at least two frames captured so there is something to scroll between. Therefore, in one embodiment, having less than two frames renders this control inoperable.

In another embodiment, a common user interface element is a help button 321. The help button 321 can be labeled with various names such as “Help,” “Show Me,” “!,” “?,” and others. The help button 321 can display a small tour of the functionalities of the application. Alternatively, the help button 321 can provide a search field where a search term may be entered and then searched in a preloaded file with help information on how to use the stop motion application. In another embodiment, the help button provides an interactive tutorial that permits the user to utilize the application while the tutorial tells the user what to do next.

Yet another common user interface element is the frame counter 336 which is located above the display window 330. The frame counter is a numeric representation of the frame that the user is currently on or viewing. In an exemplary embodiment, as shown, the frame counter 336 also shows the total number of frames. For example, if the frame counter displays the numbers “12/100”, then “12” represents the number of the current frame while “100” represents the total number of frames. If there are no frames yet recorded, the both numbers will be zero (e.g. 0/0). The frame counter can also display time, showing the total playtime of the animation sequence up to the point of the current frame. The user is thus enabled to create an animation of a specific length of time.

Therefore, when the slider 334 in the frame slider bar 332 is being dragged back and forth across the timeline, the frame counter 336 updates to correspond to the current location in the frame sequence. In some embodiments, this action causes the display window 330 to visually scroll through each frame. In other embodiments, dragging the slider 334 only displays the frame numbers in the frame counter 336 and does not display each of the corresponding frames within the display window 330. However, when the slider 334 is released, the frame image is updated in the display window 330.

In addition, when the play button is selected to view the playback of the frames, the left number within the frame counter 336 increases as the frames advance. Similarly, the left number adjusts accordingly, when the user uses the fast forward, fast back, forward frame, and back frame buttons.

Below the display window 330 are a plurality of buttons that assist the user in viewing and controlling playback of images. In an exemplary embodiment, there are buttons for play 340, forward frame 342, back frame 344, fast forward 346, and fast back 348. For example, play button 340 allows the user to playback the sequence of images that have been captured. The forward frame button 342 allows the user to advance to the next frame each time the button is clicked. Similarly, the back frame button 344 allows the user to move back to the previous frame each time the button is clicked. The fast forward button 346 allows the user to quickly advance to the last frame. The fast back button 348 allows the user to quickly go back to the first frame.

In one embodiment, the play button 340 is a two-state toggle button that has both play and pause functionalities. Pressing the play button a first time allows the user to start the playback of frames (starting at the currently selected frame) while clicking on the play button a second time allows the user to pause or stop the playback from continuing. Therefore, the visual state of the play/pause button generally shows the state that can be accessed once the button is clicked. For example, when the play icon is displayed, the playback is stopped. Clicking on the play button switches the button to pause and starts/restarts the playback.

The forward frame button 342 allows the user to step forward through the frame sequence one frame at a time. Similarly, the back frame button 344 allows the user to step backwards through the frame sequence one frame at a time. For example, when pressing the back frame button, the display window 330 refreshes to display the previous frame in the sequence, the frame slider 334 moves one notch to the left on the timeline, and the frame counter 336 regresses one frame as well (e.g., 10/10 to 9/10).

The forward frame button 342 and the back frame button 344 are generally only functional if there are frames that can be advanced or regressed to. For example, if Frame 1 is the current frame, or no frames have even been captured, clicking on the back frame button 344 does nothing. If accessed in capture mode when the live video feed is displayed, the captured frames will replace the live video feed in the display window. However, if user is on the last frame, clicking on forward frame button 342 will turn the live video feed back ON as well as a toggle the live feed button to on. Thus, if accessed in capture mode when viewing the last captured frame in the sequence, the live video feed will replace the captured frames in the display window 330.

The fast forward button 346 allows the user to quickly advance to the very last frame without having to go frame-by-frame with the forward frame button. Once the fast forward button is selected, the display window refreshes to display the last frame, the frame slider 334 moves to the right-most position on the timeline, and the frame counter 336 advances to the last frame (e.g., 10/10). Similarly, the fast back button 348 allows the user to quickly rewind back to the very first frame (i.e., Frame 1) without having to go frame-by-frame with the back frame button. Once selected, the display window refreshes to display Frame 1, the frame slider 334 moves to the left-most position on the timeline, and the frame counter 336 rolls back to Frame 1 (e.g., 1/10). If accessed in capture mode when the live video feed is displayed, the captured frames will replace the live video feed in the display window.

The loop button 350 allows the user to choose to either view the movie in a repeating loop or following a “one time through” approach. The loop button 350 has two visual states that can be toggled between on and off. When in the on position, the playback will continuously loop (i.e., the movie restarts from Frame 1 after the last frame has been reached) when play 340 is activated. When in the off position (default setting), the playback stops when it reaches the last frame. The loop button 350 can be toggled ON or OFF at any time in playback mode, including actual playback. For example, if looping is set to ON, and during playback, the user toggles the Loop button to OFF, the movie will stop playing when it reaches the last frame.

In one embodiment, there can be three capture modes: append, insert and replace. In the append more, the captured frame is added to the end of the sequence. Thus, when a frame is captured, as a default, the frame will be added to the end of the sequence of frames. When the sequence is played, the last frame captured is the last framed viewed in the playback. In the insert mode, the captured frame is added before the current frame. In the replace mode, the captured frame replaces the current frame.

In one embodiment, a grab button 356 can be available to a user. The grab button 356 is used to load the current frame being displayed on the display window 330. In one embodiment, the current frame is loaded into a separate section of memory such that it can be later utilized as a background. For example, the when the grab button 356 is pressed, a dialog box is presented to the user offering to save the current frame as a background that can later be used. In another embodiment, clicking the grab button 365 simply makes the background to be the same as the current frame.

A delete frame button 354 further provides the ability to a user to delete the current frame. The delete button allows the user to get rid of any unwanted frames, and indirectly, any audio cues and user-created audio snippets that are tied to them. When no frames have been captured, the delete button is inactive, and is visually grayed out. In another approach, the delete button can delete multiple frames. The user can be prompted for a number of frames and a starting frame, and then the frames requested by the user, including the current frame are deleted. In another approach, the user can be simply prompted for the number of frames. The deleted frames will start at the current frame up to the number entered by the user.

In one embodiment, a delete warning option is provided. Therefore, once the delete button is selected, a dialogue window appears asking the user to confirm the desired deletion. With this dialogue, there will be two (2) iconic buttons (“Cancel” and “OK” ) that allow the user to exercise his/her choice. If the user selects the “Cancel” option, then the prompt window closes, and the user is taken back to the program state prior to the delete button being selected (i.e., the last frame is replaced by the live video feed). The frame has not been deleted. However, if the user selects the “OK” option, then the prompt window closes, the current frame is deleted, and the frame slider 334 and frame counter 336 update accordingly (i.e., it subtracts 1 from both numbers).

If a user presses on this button the current frame is deleted, and the number of frames is decreased by one. The current frame then may become the frame immediately after, or immediately before the deleted frame. In addition, frames can only be deleted one unit at a time; there is no “batch” delete.

In another embodiment, an insert button 352 can be toggled ON or OFF. If the insert button 352 is set to ON, all the frames that are captured will be inserted right after the current frame. After the frame is inserted, the current frame becomes the newly added frame. In another embodiment, the current frame remains the same frame as when the insert button 352 was set to ON. When the insert button is set to OFF, then any frames that are captured are by default added towards the end of the sequence of frames. In yet another embodiment, the when the insert button is set to OFF, but the current frame is not the last frame, the replace mode is engaged. In that mode, captured frames replace the current frames. Moreover, the replace, insert and append modes can be configured by the user of the application.

When a mode is accessed via the mode switch buttons in the mode selection bar 310, the current frame remains the same. Thus if a user wishes to insert a frame, after the correct frame is located, changing modes will not change the current frame after which the new frame may be inserted. Furthermore, the user must click play 340 to start the movie playback. In one embodiment, the frames are played at a frame rate of twelve frames per second. In another embodiment, the frame rate in the movie can be changed at any arbitrary point in the movie by changing the frame hold time in the animation data.

The animation or movie can then be exported into a number of different video or movie file formats for viewing outside of the software application of the present disclosure. For example, movies may be exported as QuickTime, Windows Media Player, Real Video, AVI, or MPEG movies. It should be understood that there are numerous other types of movie files that could be used.

SET MODE

FIG. 4A illustrates a screen shot of the user interface in set mode. As mentioned before, the contents of the first portion change depending on the mode. When the mode is the set mode, the first portion of the user interface provides various operations that allow a user to set up a specific scene.

In one embodiment, the first portion comprises a canvas 400 that is utilized by a user to change and modify the scene to the user's liking. For that end, the user is provided with the ability to place on the canvas 400 multiple images, such as a background, a character with body parts (e.g. head, arm, torso, leg), a prop, or any other image. At initial stages, when the application is first lunched, the canvas 400 is empty and contains no characters or any assets. A message indicating that there the canvas 400 is empty may be displayed to the user. For example a message “Welcome to Xipster. Click the Character button to get started” may be displayed on the empty canvas 400.

In one embodiment, the user is provided with a hand button 408, and character button 404, a prop button 408, a background button 406, and a delete button 410. The hand button 402 is a move tool that permits a user to move any image placed on the canvas 400 from one position to another. In one embodiment, the user clicks on the hand button 402 and the mouse pointer becomes the form of a hand. Then the user may select images or cutouts and place them in different positions within the canvas 400. In order to do this, the user would click on the cutout, and continue pressing on a mouse button or any other device that allows continuing to select the cutout. Then the mouse pointer is dragged so that the cutout is dragged along to another position within the canvas. Once the mouse pointer is deselected, then the image cutout remains in the new place within the canvas.

The background button 406 provides the capability to insert any background as the background image. In one embodiment, after clicking the background button 406, the user interface will display a selection of computer images that the user can utilize as the background for the scene. The selection of computer images may be presented to the user as image thumbnails, a text list of names, a combination of both, etc. In another embodiment, the background image can be obtained from a video playback or a live feed camera. In another embodiment, the background image can be downloaded from the internet. In addition, background images can also be imported from variety of image file types, which can be located on a server or local computer. Every time the user wishes to replace background image, the user may click on the background button 406 once again and select another pre-stored image as the new background.

The prop button 408 allows a user to select an image as to represent an object or any other cutout that is not a character. If clicked, the prop button provides the user with a choice of pre-loaded props as well as the capability to import customized images as props. The user may then select the desired prop and place the image on the canvas 400. In one embodiment, a list of props is displayed to the user in the form of text. In another embodiment, the list of props available to the user is in the form thumbnails. To select a prop, a user may double click on an item in the list of props. Alternatively, the user may drag a thumbnail from the list of props to the canvas 400.

The delete button 410 permits a user to remove a character image a prop, or a visual effect image. If clicked, the delete functionality is activated, and anything on which the mouse pointer clicks on would be deleted if it were a character or a prop. In one embodiment, the mouse pointer changes shape to show that anything it clicks will be deleted. For example, the pointer may be in the form of an ‘X.’

The frame capture button 450 allows the user to capture a frame from the canvas 400. In one embodiment, the frame capture button 450 is labeled “Snap!”

The frame capture button 450 allows the user to capture images from the contents of the canvas. Thus, if the canvas contains an image from a supported image capture device, and a background, the frame capture button 450 will capture the contents of the canvas 400 as if taking a photograph of the canvas 400. The result from capturing the contents of the canvas 400 into a single image is a frame that is added to the collection of frames. Thus, once images are captured, these images become frames, which in turn become the basis for the user's animation or movie.

When the frame capture button 450 is pressed, a single image is recorded from the canvas 400 and stored in memory as a frame. As this happens, the frame counter 336 advances by one position (e.g. 3/3 becomes 414), and the frame slider bar 334 moves to the right appropriately. If this is the first frame captured in a new project file, this frame becomes Frame 1 (e.g. 1/1 on the frame counter). If it is not the first frame captured in a new project file, this frame is added to the end of the frame sequence. For example, if there were already ten frames captured, the currently captured image becomes Frame 11 (e.g. 11/11 on the frame counter).

The newly captured frame is immediately displayed in display window 330. Therefore, the user can immediately see whether the new frame is satisfactory.

In one embodiment, when a frame is captured, the application emits a sound as if a photograph is being taken. This helps reinforce to the user with the illusion that a snapshot of the canvas is being taken.

To add additional frames, the user can continue to click on the frame capture button 450 as many times as desired. For example, the user may wish to have a few frames that are identical to give the impression of a static situation within the video. For this purpose, the user would click on the frame capture button 450 a few times. Each frame will be added after the one before and the frames counter 336 and frame slider 334 advances accordingly. When the animation is played, the identical frames are presented one after the other so that it gives the illusion to the viewer that the video intends to have a static part or to allow music to play for longer.

The character button 404 allows a user to insert characters on the canvas 400 by selecting a character image from an image database. Once the character button 404 is clicked, many possible sources to import the character are available to the user.

For example, images may be imported from an image capture device such as a digital camera, web camera, video camera, or other image source. Images can also be imported into the application by downloading from the Internet, or even by capturing images through a device located remotely but connectable via the Internet, such as a remote web camera. In another embodiment, the images may be obtained from any non-volatile recording medium. In general, images can be imported from any image file. In exemplary embodiments, the application includes drivers for common camera devices and other storage devices such that the application can easily recognize most storage and capturing devices without prompting the user to install additional support.

FIG. 4B illustrates a computer screen shot of the application when a character image is being loaded in set mode. In one embodiment, when the character button 404 is clicked, the user is provided with a list of characters 420 from which the user can make a selection. In one embodiment, the list of characters 420 is a list of text strings representing the names of each of the available characters. The user may click on any name of a character and immediately have a preview of the character 412 on a preview window 421. By using the preview window 421, the user may quickly view each of the characters and choose the desired one. In another embodiment, the list of characters 420 is a list of thumbnails that the user may view and from which the user can make a choice. Each thumbnail can display static or still image of the character.

A user may also be provided with a capability to search for a specific name of character. Search box 414 allows a user to enter text and press enter to search for a specific character in the list of characters. The list of characters 420 would then show the names of the characters that match the search string entered in search box 414. Once the character has been chosen and the user has decided which character he would like to load to the canvas 400, the user may use an insert button 416. A user may click on an insert button 416 to insert a new character from the character list 420. If the user clicks on the insert button 416, the selected character 412 is immediately appears on the canvas 400. Thus, in one embodiment, after clicking the insert button 416, the list of characters 416 and the preview window 412 are removed from the user interface and replaced by the canvas 400. A cancel button 422 allows the user to aborting the operation of inserting a new character into the canvas 400.

In another embodiment, once the user highlights a character in the list of characters the user interface allows for the character to be edited. In one exemplary embodiment, the user interface may have an edit character 418 that permits the editing of the face of a character in the list characters 420. In another embodiment, other buttons may be available to the user to change bodily features of a character as to change the characters physical appearance. For example, the user may be able to change a characters leg or arms, or alternatively enhance or reduce any body part of the character 412.

In yet another embodiment, the user interface provides browse button to search for an image in a non-volatile recording medium or any other memory source. In another embodiment, the character may be loaded from a web camera with live feed into the canvas 400. In yet another embodiment, the character may be downloaded directly from the Internet or any other computer network from which image files may be acquired. In another embodiment, the user may load a character image that was not in the list of character images 420 from any other computer image source.

FIG. 4C illustrates a computer screen shot of the application in set mode when a character is being edited with the facelift feature. In one embodiment, each character images within the list of characters 200 may be edited by first clicking on the edit character button 418. The user may select to perform a facelift on the character by clicking on facelift button 460, or a jawdrop on the character by clicking on the jawdrop button 450. The facelift button 460 permits the user to add a face and head of another source onto the selected character. Thus, effectively the new face on the character 412 will look like a completely new character 412. The jawdrop button 450 permits a user to select a portion of the characters face to move up and down. The user would generally select the area around the mouth to create the illusion that the characters mouth is opening and closing.

If the facelift button 460 is selected, the user can be provided with a get image button 440. The image for the facelift can be selected from a variety of sources. In one example, the application provides a choice 430 of obtaining the image from a file or from a webcam. If the user selects the webcam as a source, the application may provide with a list of available web cameras configured with the program. If the user selects a file as a source, then the application may provide a browse dialog window in order to find the appropriate file and load it.

Once the image is loaded, the preview of the image is presented to the user on a first preview pane 441. The user may then select to draw a circle or any other shape around the face or head in the loaded image. In order to accomplish the correct cropping of the face and head, a hand button 432 allows grabbing a crop circle 439 and moving the crop circle 439 into the correct position in relation to the head or face to be cropped. A stretch button 434 can also be provided in order to stretch the circle vertically or horizontally so that the crop circle 439 is morphed into an ellipse that better fits the face or the head to be cropped. Once the crop circle 439 is positioned correctly and has the correct shape, a crop button 436 may be used to cutout the portion of the image inside the crop circle 439.

Next, the cropped head 443 immediately appears on a second preview pane 442. The second preview pane 442 shows the body of the selected character 412 and the cropped head 442. In one embodiment, the cropped head 443 can be repositioned in relation to the body of the character 412.

Erase buttons 438 permit the user to erase the undesired edges that were cropped with the cropped head 443. In one approach, multiple levels of erasing definition are provided to the user. This can be achieved by providing multiple erase buttons 438, each of which erases a different number of pixels in one stroke. Undesired or inadvertent erasure may be undone by utilizing an undo button 446.

In another embodiment, a set registration point button 433 is provided to the user. The set registration button 433 allows a user to set the point of attachment to the torso. The point of attachment is used as the axis of rotation and movement. Thus, a user can select the registration point to be right in the center of the head. The user may also select the registration point to be at the union of the neck and the torso. In that case the movement of the head will have a natural movement, as if the neck would be bending and the head be connected to the torso by the neck.

In another approach, the application can also provide the user with the ability to label the newly customized character by providing a text box 431 where a character name may be entered.

Finally, a done button 448 allows to save the newly customized character as a new character that may be used later and that has a name as labeled in textbox 431. Immediately after the done button 448 is clicked, in one example, the new character is displayed in preview pane 421 (FIG. 4B) and the list of characters 420 contains the name of the new character. The user may then use the insert button 416 to place the new character 412 into the canvas 400.

FIG. 4D illustrates a computer screen shot of the application in set mode when a character is being edited with the jaw-drop feature.

If the jawdrop button 450 is selected, the user can also be provided with a get image button 440. The image for the jawdrop can be selected from a variety of sources. However, selectively, the current head of the character is loaded in the first preview pane 441. Thus, the use can immediately do a jawdrop on the selected character.

The user can then select to draw a square or any other shape around the area selected for the jaw drop. In one embodiment, the user selects that area around the mouth. In order to accomplish the correct dropping of the mouth, the hand button 432 allows to grab a jaw box 451 and move the jaw box 451 to the correct position in relation to the mouth or jaw to be dropped. A stretch button 434 can also be provided in order to stretch or squish the jaw box 451 vertically or horizontally so that the jaw box 451 is morphed into a rectangular or square shape that better fits the mouth or jaw to be dropped. Once the jaw box 451 is positioned correctly and has the correct shape, a drop button 456 may be used to cutout the portion of the image inside the jaw box 451 and drop it a few pixels down.

Next, the head of the edited character immediately appears on the second preview pane 442. The second preview pane 442 shows the dropped jaw of the selected character 412 in relation to the head.

A play/pause toggle button 454 allows a user to view the movement of the jaw as it opens and closes. The user can select to play the movement of the jaw or pause it by clicking on the play/pause toggle button 454.

A jawdrop tool button 452 further permits a user to adjust how the jaw moves. In one embodiment, the jawdrop tool button 452 permits a user to select whether the movement of the jaw is to be vertical or horizontal. If the movement is selected to be horizontal, the jaw will move from right to left in a side-to-side movement. If the movement selected is a vertical movement the jaw will move up and down as if the mouth of the character would be opening and closing. The jawdrop tool button 452 can further provide the user to the capability to define the frequency of movement of the jaw.

Just like with the facelift feature, the done button 448 allows to save the newly edit character as a new character that may be used later and that has a name as labeled in textbox 431. Immediately after the done button 448 is clicked, in one example, the new character is displayed in preview pane 421 (FIG. 4B) and the list of characters 420 contains the name of the new character. The user may then use the insert button 416 to place the new character 412 into the canvas 400.

Action Mode

FIG. 5 illustrates a computer screen shot of the application in action mode. In action mode, the application provides various operations that allow a user to control the actions of the characters in the animation. The actions of the characters in the animation are controlled by changing the position of a character 412 within a canvas 400, changing the position of a limb of character in the canvas 400, etc.

Characters are created in such a way that the body parts of each character can be manipulated by the user. For example, the arm can be rotated as attached to the shoulder of the character. Yet, when the whole character is rotated, all limbs rotate together.

In one embodiment, the rotation or movement of the character as a whole is achieved by using registration points. All body parts can be assigned a registration point for placement and rotation. The torso functions as a central where the rest of the body parts are positioned relative to the torso. The position of each body part can be saved as part of the character data. As such, any action that affects the character, also changes all of the character data including the position of the body parts in relation to each other. For example, the character can be scaled to have a larger size, the body parts will not only enlarged, but also moved away from each other so as to maintain the proportionality and correct position of each body part. This can be done by readjusting the registration points of the body part. Thus, also during rotation of a character the relative position of the body parts are maintained during character rotation. This is done by first rotating the body part registration point around the torso registration point, the applying the body part's independent rotation settings to those of the character.

Every time the position of a character is changed, or anything is modified in the canvas 400, the user may take a snapshot of the canvas 400 so as to capture the modification into a frame. A sequence of modifications to the characters and contents of the canvas 400 provide the illusion of action of the characters.

In one embodiment, the operations to modify the canvas 400 are provided to the user in the form of action buttons such as a hand button 402, a rotate button 502, a scale button 504, a body part button 506, a flip button 508, layer button 510, and a delete button 410.

In one embodiment, the hand button 402 and the delete button 410 in the action mode provide a user with the same functionality as in the set mode. Namely, the hand button 402 can be used to reposition a character 412, a prop or any other image cutout that is in the canvas 400. The delete button 410 can be used to remove any character 412, prop or image cutout from the canvas 400.

The rotate button 502 allows the user to rotate a prop or a character clockwise or counterclockwise. In one embodiment, the user rotates the character image or the prop by clicking on a mouse. If the right mouse button is clicked, the image rotates clockwise, and if the left mouse button is clicked, the image rotates counterclockwise. After clicking on the rotate button, the rotate function is activated. Then, clicking with the right mouse button on a character, a body part or a prop, would make the image rotate around an axis a configurable number of degrees. For example, the image can be rotated one degree around the center point every time the mouse pointer is clicked over that image.

The scale button 504 allows a character 412, a prop or any other image cutout to be enlarged or shrunk. In one embodiment, the user may click on the upper arrow of button 504 and thereafter click on the image to be enlarged. Any subsequent clicking on any prop, character or other image cutout would enlarge the clicked image. Therefore, to deactivate the button from the enlarging subsequent images, the button can be clicked again. If the user clicks on the lower arrow of the scale button 540, the selected character or image may be shrunk. Thus a user may create the illusion of the head of a character to grow by enlarging a small amount and taking a snapshot, then enlarging the head some more and taking another snapshot, and so on.

The body part button 506 allows a user select the body part of a character and change the position of the body part. In one embodiment, the user clicks on the body part button 506 to be activated. Next, the user may select any body part of a character to manipulate it. For example, the user may select a leg of character 412. Thereafter any manipulation is done only on that limb until the body part button 506 is clicked again.

In another embodiment, the body part button 506 may be clicked to toggle the position of a limb. For example, an arm of a character may have two possible positions available: straight and bent. Once the body part button 506 is activated, the clicking on the arm of the character would make the arm bend if it was straight, or straighten the arm if it was bent. Thus, repeated clicking on the arm would toggle back and forth from a bent position to a straightened one.

The flip button 508 allows a user to flip the orientation of a character, a prop, or any other image cutout. In one embodiment, the user clicks on the flip button 508 and thereafter clicks on the character 412 in order to flip the character's orientation horizontally. Thus, if the character 412 was oriented to the right, with for example the chest facing to the right, after the user clicks on the character 412, the character is then oriented to the left, with the chest facing to the left. Thus, a mirror effect that flips the orientation of the character is accomplished. In another approach, the orientation is flipped vertically.

The user also has the capability of layering by using the layer button 510. Once clicked, the layer button is selected. Then, with the mouse pointer an image cutout, character, prop or visual effect is clicked on. On every click, the image cutout is positioned in a different layer with respect to other cutouts. Thus, an image cutout can appear in front or behind another image cutout, character, prop, or visual effect. If for example there are tow props and a character, clicking on the character one, would send the character all the way to the back. Thus giving the illusion that the character is in tri-dimensionally behind the two props. Another click on the character can bring it in front of one prop, and keep the character behind the second prop. Yet another click on the cutout can bring it completely forward in front of both props.

In the action mode, a user also has the ability to assign a cycle of movements to a character or a prop. The cycle of movements is predefined human movements such as jumping, running, and flipping. For example, a cycle of movements that defines running would comprise extending the right leg, bending the left leg, straightening the left leg, and bending the right leg. Playing this sequence of movements would give the impression of rapid leg movement of a character and would be perceived as running. Another cycle can include the same leg movement and in addition comprise the translation of the character across the background.

The pre-stored cycles can be applied to any character. In one embodiment, the pre-stored sequence of movements is provided to the user. These cycles provided to a user follow an algorithmic approach. Thus, in one embodiment, a cycle of the characters is preprogrammed to be part of the software and are cannot be altered. These movements of the characters are not made frame-by-frame, but rather they are preprogrammed sequence of movements of each limb independent of the rest of the scene. When applied to any character, these cycles trigger the character to behave in a predictable way.

In another embodiment, the user may design personalized and unique sequence of movements and save them so that they can be applied in the future. The sequence of movement can be stored in the form of a file that contains data representative of the position of the character or prop within the canvas 400.

A cycle button 520, a cycle play button 522 and a cycle pause button 524 are provided to a user. Once a user clicks on the cycle button 520 and subsequently clicks on the character 412 to which the cycle is to be applied, a list of available cycles is displayed. In another embodiment, the user clicks on the cycle button 520 and then hovers over character with the mouse pointer. When the mouse pointer hovers on the character, a menu shows with cycle options such as “auto-walk,” “auto-run,” etc.

The user may then select one of the items in the list and the corresponding cycle is applied to the character 412. Next, the cycle play button 522 can be pressed to view the movement for the character with the applied cycle. The user may choose to snapshot randomly as the cycle plays, and the frames captured would reflect the moment within the cycle when the snapshot was taken. As such, taking a snapshot when the cycle is playing closely resembles the experience of taking a photograph of a moving object. Alternatively, the cycle pause button 524 may be pressed to pause the movement of the cycle. The user may chose to use the cycle pause button 524 to be able to take the snapshot of the exact position of the character without moving.

Thus, allowing the cycle to play and continuously taking snapshots of the cycle would permit a user to capture sequential frames that show the movement of the cycle. This feature allows a user to save time that would have otherwise been used in readjusting the image cutouts back and forth the so as to achieve the movement of the characters, props, or image cutouts.

In another embodiment, once the cycle button 520 is clicked, a user may hover over each of the characters to see if a cycle has been assigned. If a cycle has been assigned, the cycle may start playing on the character as form of preview.

In another embodiment, a special effects animation can be synchronized with the characters. Special effects animations such as explosion or lighting, which occur over a series of frames, may be seamlessly added by clicking on a visual effects button 530. In one embodiment, the user picks a frame by positioning the display window 330 to show the desired frame. To pick the correct frame, the user may take into consideration the number of frames that the animation will last. Each special effects animation may provide a frame counter to show how many frames the effect will cover.

Once the frame has been chosen, the effect may be positioned on the canvas 400 using the move, rotate, and scale tools. In one embodiment, the user may drag the effect from a list of effects onto the canvas 400. Once the effect is positioned where the user wants the effect to happen, the user may use the frame capture button 450 to include the effect in the current frame. In another embodiment, an insert button may be provided for the user to insert the effect on the current frame.

Visual effect animations that can be inserted include flash animations, and others. In one embodiment, a flash animation can be used as a character, prop or a visual effect. The flash animation frames can be synchronized to advance as the frames are captured. If there is more than one flash animation, they can also be synchronized to advance frame by frame in relation to each other.

FIG. 5B illustrates a computer screen shot of the application in action mode displaying a functionality to capture multiple frames. In one embodiment, if the user selects the cycle button 520, and plays a cycle by clicking on play button 522, a snap all cycles button 550 can be added to the interface. The snap all cycles button 550 can be configured to take a snapshot of a sequence of movement by taking sequential snapshots of the character with the applied cycle. For example, the user may select a character and apply a running and jumping cycle. The user can be provided with the option to take snapshots by repeatedly clicking the snapshot button 450 while the cycle is playing on the character. Every time the user clicks on the snapshot button 450 the frame will capture the current movement of the character. But if the user does not click on the snapshot button 450 repeatedly and quickly, some movements of cycled character may not be captured. For instance in the running and jumping cycle, part of the upwards movement in the jumping may not be captured, and as a consequence when the frames are played, that part of the movement will show as being omitted.

When the snapshot button 450 is clicked and there are animated characters or images on the canvas 400, the frame will be captured as a single image containing the still image of the animated character. Then all of the animated objects will be advanced to the next position in their respective animation cycles and captured in the next frame. This allows the user to manipulate the characters in the middle of an animation sequence using all of the tools that are available in set mode.

In another embodiment, the user can click on the snap all cycles button 550 a single time and the application would capture, for example, twenty frames with each of the movements in the cycle of the character. The number of captured frames can be configurable by the user or “hard coded” as part of the application software. Thus, the user saves time and energy by simply clicking once on the snap all cycles button 550 because twenty frames will be added with the cycle applied, with minimum effort and synchronization by the user.

With the use of the play button 522 and the pause button 524, the user can play the cycle being applied to a character until the character is in a desired pose. Then the snap all cycles button 550 can be selected to capture the next twenty movements within a cycle, each movement captured in one frame.

When snapshot button 450 or the snap all cycles button 550 are used, the animation cycles of each character or other image can be synchronized with the Flash animated objects, which could include props, backgrounds, visual effects, Flash characters. Hence, the synchronization of the animation of each of the animated images, and the cycles of the characters permit each frame to present new movement and give the viewer the illusion of coordinated movement of the animated images and the static images that have been applied cycles.

Additionally, multiple cycles can be applied to different characters. Each frame captured by the functionality of the snap all cycles button 550 will include the sequential movement of the characters following the particular cycle that was applied to each character. Thus, if a character, a pre-animated prop or an active visual effect are simultaneously on the canvas 400, each frame captured by the functionality of the snap all cycles button 550 will include partial movement or action of the props, characters, visual effects, and backgrounds which are configured to move. In one frame, for example, on character moves a leg, another character moves an arm, and a prop partially rotates to the right. This feature allows the user the easily and quickly create realistic animations in which multiple image cutouts move in synchronicity with each other.

Sound Mode

FIG. 6A illustrates a computer screen shot of the application in sound mode. Sound mode allows the user to add synchronized audio to his/her movie by selecting from pre-recorded, supplied audio (e.g., music and sound effects) and/or recording his or her own audio through a microphone and the computer's microphone or line-in connection. In an exemplary embodiment, sound mode provides four categories of audio which may be inserted, including voice or other recorded audio, sound effects, and music. Buttons 602, 604, 606, and 608 are provided for the user to easily choose between the different types of audio.

In one embodiment, the user needs to determine where to add audio and how long the audio should last. In another embodiment, the user may just insert the sound where the sound must start playing and continue animation until a new sound or silence is inserted.

In general, audio is added and synchronized to an animation on a frame-to-frame basis. Audio is added to animations by inserting an audio cue at the desired frame within the animation. The audio cue indicates that audio should start playing at that frame. In one embodiment, then an audio cue has been inserted in a frame, a visual indicator or icon appears next to the display window to indicate an audio cue is present. The user can click on the audio cue icon to preview the audio to be played by the audio cue or to easily delete the audio cue.

In one aspect, audio continues to play until the audio ends. In another aspect, audio may be looped to play continuously until the end of the animation. In yet another aspect, additional audio cues may be inserted at a later frame to indicate where the audio should end. Audio cues and the method of inserting and deleting audio cues is discussed in more detail below.

When an audio cue is assigned to a particular frame in sound mode, an iconic representation of that cue (one per cue type) appears above the display window next to the frame counter. This makes it easier to identify cues for future editing.

The sound effects button 602 allows the user to insert sound effects into his or her movie. In an exemplary embodiment, the stop motion animation application includes a plurality of pre-programmed sound effects which are available to the user.

A sound effect menu provides a list of available sound effects and allows the user to select and preview sound effects. In an exemplary embodiment, when the user clicks on an audio file name within the sound effect menu, the sound effect's file name becomes highlighted, and the sound effect is played aloud. This allows the user to preview each of the different sound effects prior to inserting into the animation. In the case of certain sound effects that are relatively long in duration, only a portion of the sound effect will play for this preview. Sound effects are added to the animation by attaching the sound effect to a specific frame using the insert button 612. Thus, the user can locate the frame at which the sound is to be played and once located, the insert button 612, if pressed, would add a cue to play the selected audio.

The voice button 604 displays a list of prerecorded voices. A menu of pre-recorded voices appears for the user to select and can be inserted at any point in the animation. The record button 620 allows the user to record his/her own audio clips through a microphone or line-in connection. In one embodiment, once the voice button 604 is selected, a graphic appears prompting the user to record audio and the record button 620 and recording status window 624 appears. Provided that the user has a microphone or audio source connected via the mic/line-in, he/she is now ready to start recording audio to be used in his/her animation. In another embodiment, the record button 620 is readily available along with destination buttons 622 that allow the user to select whether the sound is recorded directly to the animation at that frame, or whether it is recorded to the library so that the voice an be used later. If the user selects to record directly to the animation, a option can be provided to save the voice to the library as well.

In one aspect, the record button 620 is a toggle button which has two states: record, and stop. The button shows the state that will be entered once it is pressed. Therefore, when the button reads “record”, recording is stopped. Similarly, during recording, the button reads, “stop.” The user clicks on the record button when recording is complete to stop recording.

In one embodiment, once the record button 620 is selected, a “3-2-1” countdown is displayed and optionally a countdown sound effect plays for each number. This provides the user warning that recording is about to start. Just prior to following the “1”, the button changes from its “record” state to “stop”, the recording status window's 624 text changes to “Recording”, and audio recording is initiated.

Simultaneously, play 340 becomes auto-selected/engaged (i.e., it visually changes to its pause state), the frames begin playback starting from the current frame, all other playback controls (forward frame, back frame, fast forward, and fast back) become inactive, and the frame counter 336 begins to advance accordingly.

To stop recording, the user selects the record button (now in its “stop” state) again. When this occurs, the record button changes back to its unselected state (“record”), the recording ends, and the audio cue is associated with the frame displayed at the first frame of the recording sequence. Behind the scenes, the audio file will have been saved to the audio files folder under a name that is assigned by the program.

During recording, the user has the option of pausing audio recording (by pressing stop) if they need to take a break during recording. When the user is ready to resume recording, the user needs only to press the record button again, and the recording will pick up where he/she left off. In this instance, separate audio files (and sound cues) will be created; the user is not adding onto the previous sound file. This “recording in pieces” technique is advantageous to the user as it allows them to easily find (and potentially delete) a particular piece of audio instead of having to delete everything and then start over from scratch. If the user attempts to change modes during audio recording, the recording is stopped immediately, but the clips are retained just as if the user pressed Stop first.

Generally, once recording has been initiated, recording continues until either the animation or sequence of frames has reached the last frame or the user has pressed stop. During recording, any already existing audio cues are muted. Once recording has stopped, audio cues are returned to their active/playable status. The recording status window 624 helps further identify whether or not recording is initiated. The recording status window indicates to the user when recording is in progress or when recording has been stopped.

In one embodiment, audio is recorded for a length of time that matches the time that it takes for all the captured frames to playback. Recorded audio having a length that exceeds the total length of the animation is discarded. For example, if the user has 10 seconds worth of frames but tries to record 20 seconds of audio, then only the first 10 seconds of audio is retained.

The music button 606 allows the user to add music accompaniment to his or her animation, and more specifically, to access the controls for adding custom music loops into his or her movie. A music menu 616 allows the user to select and preview custom music loops from its directory. The music menu 616 comprises a list of music files that can be attached to specific frames within the animation by using the insert button 612. If the user clicks on an audio file name within the music menu, a snippet of the selected music loop is played aloud.

In another embodiment, an import mp3 button may be provided. Additional music, sound effects and voice may be downloaded in mp3 format. Other music formats may be supported. For example, any type of music file, such as an audio file in mp3 could also be imported in wav format into the application and listed in the music menu.

Furthermore, sound effects can also be imported in multiple sound formats into the application. For example, sound effects could be retrieved from the Internet and added to the list of available sound effects within the application. Alternatively, the user could record or create his or her own sound effects and import them into the application.

Multiple audio can be played at the same time. A user can insert an audio cue for an audio file during a period where another audio file is playing. For example, a song may start playing on Frame 1, and a “Pow!” sound effect can be configured start playing on Frame 10. Assuming that the sound effect lasts 20 frames, the audio for the sound effect should end on Frame 30. However, the song may continue playing until the end of the animation. In another embodiment, a trigger all sound to be stopped. In yet another embodiment, a song named “Silence” may be recognized as only stopping the output for any song that is playing.

In another embodiment, a fill frames button (not shown) can be provided to add multiple dummy frames to fill up a time space. For example, a user may wish to add multiple black frames at the end of a sequence so that a song may finish playing. The fill frames functionality will fill up the necessary frames needed for the song to play in its entirety. The frames displayed will contain no image data, thus saving storage space, yet when played, the last frame can be displayed. The user may also select to display a blank image.

FIG. 6B illustrates a computer screen shot of the application in sound mode displaying various audio options. In one exemplary embodiment, the user is able to configure multiple audio options. Configurable options include music level, sample rate for recording, sample depth for recording, input channels, output channels, setting recording folder, setting sound effects folder, setting music folder, etc.

The application may be implemented to display music level radio buttons 632 to select the output music level Low, Medium and High. Likewise, a sample rate radio buttons 634 allow the rate to change in frequency (e.g. Low at 11 KHz, Medium at 22 KHz, and High at 44 KHz). Sample depth radio buttons 636 give the option of changing from Low (8 bit) to High (16 bit). Sound channels are configurable by using channels radio buttons 638. In one embodiment, the available channels are Mono and Stereo. In addition, a recorded sound folder button 640 displays a browsing window to select the folder in which the recorded sounds can be stored.

Mods Mode

FIG. 7A illustrates a computer screen shot of the application in mods mode listing possible modules. Modules are advanced features that make the building of the animation more enjoyable and intricate. In an exemplary embodiment, some modules can be provided to the user as part of the stop motion application. Other modules can be available to the user by downloading them form the Internet. Examples of modules are Frame Capture, Titles, Blue Screen, and Video Import.

Active modules buttons 702 are provided to the user for selection and usage. Inactive modules buttons 704 list other available but not installed modules. The uninstalled modules are grayed out and can have a button labeled “Get It” for the user to download from the Internet. The user may download by paying a price or without paying anything depending on the configuration of the application.

An updates button 708 can also be provided so as to refresh the list of inactive modules 704 and displayed grayed-out the new features available for the user to download.

As it can be seen from FIGS. 7B-7G, in another embodiment, each module features an options button 701. This button can bring up a panel containing options that are specific to that module and which are independent of the other modules. In addition, each module has a close button 703 which will close the module being used and display again the module selection menu.

FIG. 7B illustrates a computer screen shot of the application in mods mode displaying the frame capture module. The frame capture module permits a user to capture a frame from a webcam or any other video output. The live feed from the camera can be displayed in display 720, and the frame capture button 450 can be provided to take snapshots of the contents of the display 720. A user may choose to have some frames in the animation to be frames captured from a live feed image, and other frames using preloaded image cutouts of characters and props.

FIG. 7C illustrates a computer screen shot of the application in mods mode displaying the titles module. The titles module allows a user to add a title to an animation. In one embodiment, a user may create a new frame for the title. In another embodiment, the user may utilize an existing frame to add the title.

If the user wishes to create a new frame, the user would select a background for the new frame by clicking on a pick a background button 740. The frame capture button 450 is also provided so that after the user selects a background, adds the text and captures the frame. The text can be added at any point in the sequence of frames, either as an opening sequence, end credits, or text any frame. In another embodiment, the user can capture an image/frame from the video input device and use it as the movie's background for the “opening shot.”

After a background is selected, the text can be added by simply double clicking the text frame display 730 and a cursor appears for typing text. Buttons 732, 734, 736 and 738 allow editing font, size, color, and style of the text.

In one embodiment, the frame capture button 450 adds the new frame in the position where the current frame is being displayed in display window 330 (FIG. 3). Thus for the text frame, the default is not adding to the end of the frames but inserting the frame at the current position. In yet another embodiment, the frame is always inserted in the beginning of the animation as frame 1. As a result, all frames get “pushed” forward 1 frame once a title frame is captured (e.g., the title frame becomes Frame 1, the previous Frame 1 becomes Frame 2, and so on).

In one embodiment, the title frame is displayed/held for five seconds (i.e., the equivalent of 60 captured frames when played back on 12 fps) during playback. This “frame hold’ is designed to give the effect of a opening credits/title shot without making the user have to physically create sixty frames to accomplish the same effect. For example, a user using sliding text, can use the frame hold feature to allow multiple frames to be played back with the text is being slid across the screen.

In yet another embodiment, text may be added to an existing frame. A user can be provided with a grab a frame button 742 that allows a user to search for a specific frame within the animation. Next, once the user selects the frame, the frame is displayed in the text frame display 730.

Then the user may double-click on the text frame display and add text to the frame. In one embodiment, a textbox appears on the text frame display 730 and the user may add the text directly on the text frame display 730. In another embodiment, a dialog box may appear presenting a textbox where the text must be entered. Buttons 732, 734, 736 and 738 allow editing font, size, color, and style of the text.

In another embodiment, adding a title in the present application is limited to merely taking a snapshot of text (or any other image, for that matter) that the user has created outside of the application.

Frames or images in the application can have associated typed text. The text will be displayed during playback in authoring mode. It will also be exported with the movie. Each frame in an animation can also have an associated URL. When the project or exported movie is played back, a click on that frame will open a web browser that will take the user to the specified URL.

FIG. 7D illustrates a computer screen shot of the application in mods mode displaying the blue screen module using the LIVE functionality which allows the user can alter the background. When the image for a character is imported from a camera, and the user wishes to keep an image background, then a user may choose to use the blue screen module. For example, after the user has shot a few frames with a specific background, the user may wish to introduce a new character whose image comes through a live feed camera. A blue screen module allows the character captured by the camera to be seen on the canvas 400, and simultaneously show the original background of previous frames in the canvas 400.

The blue screen module can provide for a live blue screen module or a post blue screen module. In one embodiment, the user may choose the blue screen module or a post blue screen module by either selecting on a blue screen live button 762 or a blue screen post button 763.

In one embodiment, the blue screen live module allows the user to remove a background in real time by using a color picker. The color picker, in one approach, may be a set background color button 754. If the set background color button 754 a color palette is displayed with a choice of colors. A color range counter 756 and a color rage slider 758 may also be provided so that when the color is chosen, the color becomes transparent in the live video feed. Thus, once picked, the picked color is removed from the video image, allowing it to be superimposed over the background image. A set background image button 750 can help to locate the video source or the source for the background image if the user wishes to have a background image as well as a live video feed from the camera. Likewise, if a background image is selected, a background removal off/on button 752 permits to turn off the background image in case the video feed is not visible.

FIG. 7E illustrates a computer screen shot of the application in mods mode displaying the blue screen module using the POST functionality. In one embodiment, the blue screen module allows a background to be removed after a frame has been shot. In order to do this, the background image is set using a set background image button 772. In an exemplary embodiment, the selected background image is displayed in a background thumbnail 773 positioned next to the selected background image button 772. A frame is selected using a grab xipster frame button 770. Next, the background color is selected using a set background color button 774. The background color can be selected in various ways. In one embodiment, the user can choose a color from a palette displayed to the user. In another embodiment, the user can chose the color using a color picker which allows the user to simply click on any part of the screen and select the color of the pixel that was clicked. In yet another embodiment, the user may choose the color by selecting one or more regions from the background image. All colors in the selected regions will become transparent, allowing the captured image to be superimposed over a background image. The background color may be removed by utilizing a composite image button 776. Once clicked, a selected background color may be removed from the background by overlapping frames onto the background.

FIG. 7F illustrates a computer screen shot of the application in mods mode displaying the video import module. The video import module provides the user the ability to integrate video playback with an animation. For instance, a video playback may be inserted to play on a cutout image of a television screen. Thus throughout the animation, the television in the animation may show a video playing. In another embodiment, the video may be the background, and the animation of the characters and other image cutouts occurs overlaid on the video playback.

The user has the ability to import a digital video, such as a QuickTime movie, into the application canvas 400. A load QuickTime movie button 780, when clicked, allows a user to browse through computer directories and load a movie. In one embodiment, the movie may be added towards the end of the animation and create new frames. The loaded movie may show up as part of the background in canvas 400 utilizing only the very first frame of the movie.

In another embodiment, the movie may be inserted as a background on existing frames. A user may pick a frame to insert the video background by clicking on a grab frame for set background button 782. In one embodiment, the clicking of the button provides a user a dialog box to enter a number that indicates the number of the frame in the animation. In another embodiment, the user is provided with a window with frame thumbnails. In yet another embodiment, the user may utilize the controls present as part of the common user interface elements. Once the movie is loaded and the frame has been picked, the contents of the frame are placed on the canvas. All the props, characters, and any other image cutouts are also placed on the canvas for manipulation. The background is a frame of the loaded movie, in one approach the first frame.

Movie control buttons 784 are also provided to the user so that the user may browse through the frames of the movie. For example, a user chose to utilize only parts of the video and therefore the frames that can be used of the video are selectable. Movie control buttons comprise forward frame, back frame, play/pause, fast forward, and fast back. Using the frame capture button 450 a user may capture only certain frames of the movie to be part of the animation.

In another embodiment, a frame capture all button 786 may be provided to capture all the frames in the movie and make them part of the animation. The frame capture all button 786 can be labeled for example: “Snap All.” The capability to capture all frames at once saves the user time because he/she does not need to click on the frame capture button 450 every time a frame of the movie is to be added. Thus, when the frame capture all button 786 is clicked, the loaded movie can be played and the application would capture the movie by taking a snapshot intermittently. The frequency of the snapshot can be altered depending on user preferences. For example, a user may select to take a snapshot every second, or every nanosecond, etc. The frames are captured not only with still images of the movie as a background, but also with all the characters and props that are loaded.

On the other hand, the single frame capturing that can be achieved by utilizing the frame capture button 450 allows for flexibility in choosing which frames of the movie will be part of the application and which will not.

Many other modules may be available to a user. For example, another module can permit the storing of a sequence of animation instructions. Thus a user may save the loading of a character, placing the character in a certain position within the canvas, inserting a song at Frame 4, and add a new background on Frame 10. This process may then be applied to another animation selected by the user.

Additional modules can be installed after the initial installation of the application. The application can automatically detect the new modules and make the module functionality available as another feature of the application. The modules are granted access to application data to perform functions such as adding new frames, loading captured frames into the module, changing program modes, accessing settings, and pressing or flashing buttons.

Exchange Mode

FIG. 8 illustrates a computer screen shot of the application in mods mode displaying the exchange module. The exchange module allows a user to share animations and other media that can be used in animations. In one embodiment, the exchange module has two main features: import and export.

In the import feature, different tools and elements may be imported from other sources and used in the animation. These tools and elements that can be imported include props, characters, sounds, video, cycles, etc. In one approach, a user can be provided with an mp3 button 802, a face button 804, an image series button 806, a background button 808, and a video button 810. The mp3 button 803 permits a user to select an mp3 type file from a directory in the same computer in which the application is loaded, or from an external source such as an mp3 player, intranet or Internet server, etc. In like manner, the face button 804, the image series button 806 and the background button 808 permit a user to choose an image or an image cutout to be imported into the application. The source of the image or image cutout may be the Internet, any storage media device, etc. The video button 810 allows a user to download video file and store it in a library.

In the export feature, characters, props, animations, and any other saved creation by the user may be shared through the export feature. In one embodiment, the export feature is implemented by three buttons export movie 812, upload movie 814, and convert 816. Additionally the export feature has a set format pull down box 818 that allows a user to select the format of the exported movie. Possible formats to export the movie are AVI, DV stream, AIFF audio, wave audio, image sequence, BMP image, PICT image, MPEG4 movie.

The exporting or uploading of a move may be accomplished by setting up a direct connection to transfer the files to a web space defined by the user. In one embodiment, the application includes an file transfer protocol (FTP) client that establishes a connection with an FTP server, authenticates using username and password if necessary, and uploads data to the FTP server. The FTP connection may be limited to only transfer files with video-type extensions in order to reduce security breaches. In another embodiment, any other protocol for file transferring may be used.

Thus, if the export movie button 812 is selected, the animation file or movie file may be transferred directly to a peer computer or a network server using a transfer protocol. The upload movie button 814 will allow a user to directly upload a movie file or animation file to a web space. In one embodiment, the user sets up the server address and authentication information previously. The upload movie button 814 can implemented such that when the user clicks on it, a window with the available movies and animations that are ready to be uploaded is displayed. The user then selects file to be uploaded, and confirms the upload. A connection is then established with the server and the file is transferred to a webspace. The file may then be accessible through the Internet and be shared with others.

The convert button 816 implements the functionality of converting the animation from one format to another so that the animation can be shared with multiple users. The format is established by utilizing the set format drop down box 818

Other features and animation techniques may be included with the present application and be downloaded from the Internet. For example, two images can be combined to create a single movie frame using a chroma-key composite technique. The user can select an area of the screen with the mouse to define a group of colors that will be replaced by pixels from the same location in another image. Subsequent colors that are selected will be added to the existing set of colors that are removed in creating composite images. The composite image process can be applied repeatedly, allowing an indefinite number of images to be combined. The composite image process can be applied to a series of images. The composite image operation can be undone in the case that the results are not satisfactory. The background colors can be reset at any time.

Shadow frames are used to apply a variety of techniques for guiding the animator. These techniques include rotoscoping, marker tracks, and animation paths. Shadow frames are images that are stored with the frames for a project, but are displayed selectively while creating the animation. The shadow frames are blended with the animation frames or (live video input) using and alpha-channel to create a composite image. Shadow frames will not appear in the exported movie. Shadow frames can be used as a teaching tool, allowing the instructor to make marks or comments to direct the student toward improved animation techniques. The marks and comments can be written text or drawn marks.

The time-lapsed capture feature allows the animator to capture images at user-specified intervals until a maximum time limit is reached. The user could, for example, capture images at 10-second intervals for a maximum of 60 seconds. In this example, a single click to initiate the capture sequence would produce six captured frames. This process can also be limited to a specified number of captured images.

Animations in the present application can be saved in a plurality of different formats. An animation in progress may be saved in a plurality of separate external files or in one single file. In one aspect, the animation is saved as a Macromedia Director text cast member. Alternatively, animations can be saved as Synchronized Multimedia Integration Language (SMIL) or in Multimedia Messaging Service (MMS) format.

In another aspect, the animation may be saved as a collection of image data. For example, the application may save image data in a format comprising a text file, a plurality of image files, and one or more audio files. The text file comprises control data instructing the application how the plurality of captured images and audio should be constructed in order to create and display the animation. For example, the text file comprises control data representing each of the audio cues. This may include a reference to the audio file to be played, and the frame number at which the audio file should start playing.

The text file may also contain information about each of the frames within the animation. Alternatively, the text file may contain information about only selected frames, such as only the frames that contain audio cues. The text file may contain control data that include references to images, audio or other data that can be stored externally or within the project data file.

In another embodiment, the data is associated with each of the plurality of images as metadata, such as audio queues associated with an image or frame.

In another aspect, the animation may be converted to a single video or movie file format. The animation can be exported into a number of different video or movie file formats for viewing outside of the software application of the present disclosure. For example, movies may be exported as QuickTime, Windows Media Player, Real Video, AVI, or MPEG movies. It should be understood that there are numerous other types of movie files that could be used.

In one embodiment, the stop motion animation software of the present disclosure is designed to run on a computer such as a personal computer running a Windows, Mac, or Unix/Linux based operating system. However, it is anticipated that the present application could be run on any hardware device comprising processing means and memory.

For example, the present application could be implemented on handheld devices such as personal digital assistants (PDA) and mobile telephones. Many PDA's and mobile telephones include digital cameras, or are easily connectable to image capture devices. PDA's and mobile telephones are continuing to advance processing and memory capabilities, and it is foreseen that the present stop motion animation software could be implemented on such a platform.

Furthermore, animations/movies created on using a mobile phone can be transmitted directly to another phone or mobile device from directly within the mobile application. Movies can also be sent to mobile devices from the PC/Mac version of the present application or from a web-based version of the application. Movies can be transmitted over existing wireless carriers, Bluetooth, WiFi (IEEE 802.11) or any other available data transmission protocols. A variety of protocols, including SMILL, MMS and 3GPP may be used by the application to ensure compatibility across a wide spectrum of mobile devices.

In another embodiment, the stop motion animation application can be implemented to run on a web server, and is further used to facilitate collaborative projects and sharing exported animations/movies across various platforms. For example, a movie created on a PC installation could be exported and sent to a mobile phone. The web based version of the application uses HTTP, FTP and WAP protocols to allow access by web browsers and mobile devices.

In another embodiment, other applications can be accessed directly from within the present application to import data for use in creating an animation. For example, images created using an Image program can be added directly to an animation in the present application.

In another embodiment, the present application is implemented on a gaming platform. Common examples of gaming platforms include, but are not limited to, Sony PlayStation, Xbox, and the Nintendo GameCube.

Although certain illustrative embodiments and methods have been disclosed herein, it will be apparent form the foregoing disclosure to those skilled in the art that variations and modifications of such embodiments and methods may be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

1. A computer software method for creating a computer animation using image cutouts, comprising:
providing a user interface, the user interface comprising a first window portion wherein images can be manipulated to create a frame, the frame being one of a plurality of frames which make up a computer animation, and a second window portion wherein the plurality of frames are displayed to preview the computer animation;
permitting the user to load at least one image into the first window portion;
providing the ability to edit the at least one image in the first window portion;
allowing the user to create a frame by capturing the contents of the first window;
adding the frame to the plurality of frames displayed in the second window portion; and
displaying the plurality of frames in the second window portion as an animation.

2. The computer software method of claim 1, wherein the at least one image is a background image or an object image.

3. The computer software method of claim 1, wherein the at least one image is a character image having multiple body parts, each body part being represented by an image cutout.

4. The computer software method of claim 1, wherein the at least one image is a two-dimensional image or a three-dimensional image.

5. The computer software method of claim 1, wherein the at least one image is a video image.

6. The computer software method of claim 1, wherein the user loads the at least one image from a memory source.

7. The computer software method of claim 6, wherein the memory source is a hard drive, CR-ROM, or floppy disk.

8. The computer software method of claim 1, wherein the user loads the at least one image by downloading the image from the Internet.

9. The computer software method of claim 1, wherein the user loads the at least one image by capturing an image from a web cam, the web cam being in communication with the computer software.

10. The computer software method of claim 1, wherein the ability to edit the at least one image comprises the ability to move the at least one image from a first position to a second position.

11. The computer software method of claim 1, wherein the ability to edit the at least one image comprises the ability to resize the at least one image.

12. The computer software method of claim 1, wherein the ability to edit the at least one image comprises the ability to rotate the at least one image.

13. The computer software method of claim 1, wherein the ability to edit the at least one image comprises the ability to crop the at least one image.

14. The computer software method of claim 1, further providing the user the ability to edit a character image having multiple body parts.

15. The computer software method of claim 14, wherein the character image can be edited so that the head can be replaced with a second image.

16. The computer software method of claim 14, wherein the character image can be edited so that an image portion of the character image corresponding to the mouth of the character can be cropped and moved back and forth.

17. The computer software method of claim 14, wherein the character image can be moved so that all body parts of the character are moved together.

18. The computer software method of claim 14, wherein the character image can be moved so that only one body part of the character is moved.

19. The computer software method of claim 14, wherein the character image can be resized so that all the image cutouts representing each body part are proportionally resized.

20. The computer software method of claim 1, further providing the user with a clickable “snapshot” button to capture the contents of the first application window as a single image.

21. The computer software method of claim 1, wherein the frame includes a background image and at least one character image, wherein the at least one character image is overlaid on the background image.

22. The computer software method of claim 1, further comprising permitting the user to view the sequence of frames in the order in which the frames were added.

23. The computer software method of claim 1, further comprising allowing to delete a frame.

24. The computer software method of claim 1, further comprising allowing a user to insert a frame before or after another frame in the sequence of frames.

25. The computer software method of claim 1, further comprising allowing a user to replace a frame in the sequence of frames with a new frame.

26. The computer software method of claim 1, further comprising allowing a user to delete a frame in the sequence of frames.

27. The computer software method of claim 1, further comprising allowing a user to delete more than one frame in the sequence of frames with a single action.

28. The computer software method of claim 1, further comprising permitting a user to add a plurality of blank frames containing no image data, the number of blank frames added being determined by the playtime of an audio associated with the animation.

29. The computer software method of claim 1, further providing the ability to insert and synchronize audio to the sequence of frames by attaching an audio cue to the image where the audio is to begin.

30. The computer software method of claim 1, wherein the second application window displays the contents of the first application window, such that the manipulation to the at least one image on the first application window is also displayed in the second application window.

31. The computer software method of claim 1, further comprising compiling a video file using the plurality of frames in a sequential order.

32. The computer software method of claim 1, wherein the first application window comprises a plurality of layers, each layer of the plurality of layers corresponding to each image loaded to the first application window, and wherein the frame is made by superposing each layer in the plurality of layers so as to create a single image.

33. The computer software method of claim 1, further comprising providing the ability to save a sequence of movements of an image such that the saved sequence of movements may be applied to a second image on the first application window.

34. The computer software method of claim 1, further comprising providing the ability to save a sequence of movements of an image such that the saved sequence of movements may be applied to a second image on the first application window.

35. The computer software method of claim 34, wherein the sequence of movements applied to the second image can be captured in a multiplicity of frames by a single action, wherein each frame of the multiplicity of frames contains a different position of the second image.

36. A computer software method for creating a computer animation using multiple images, comprising:
providing a user interface, the user interface comprising a first window portion wherein images can be manipulated to create a frame, the frame being one of a plurality of frames which make up a computer animation, and a second window portion wherein the plurality of frames are displayed to preview the computer animation;
importing at least a background image and a foreground image into the first window portion;
providing the user the ability to manipulate the at least one character image in the first window portion;
allowing the user to create a frame by capturing the contents of the first window;
adding the frame to the plurality of frames displayed in the second window portion; and
providing the ability to create another frame in the first window portion using the previously created frame.

37. In computer readable media, a stop-motion software system, comprising:
a user interface having a first window portion wherein image cutouts can be manipulated to create a frame, the frame being one of a plurality of frames which make up a computer animation, and a second window portion wherein the plurality of frames are displayed to preview the computer animation;
loading logic to load at least one image cutout and a background into the first window portion;
editing logic to load edit the at least one image cutout in the first window portion;
capturing logic that permits a user to capture the contents of the first window as a single frame; and
collecting logic that adds each of the captured frames to the plurality of frames displayed in the second window portion.
